(19) United States
(12) Patent Application Publication
(10) Pub. No.: US 2022/0253065 A1
(43) Pub. Date: Aug. 11, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: MASATAKA TOYOURA, TOKYO (JP)

(21) Appl. No.: 17/597,356

(22) PCT Filed: Jun. 17, 2020
(86) PCT No.: PCT/JP2020/023763

§ 371 Date: Jan. 4, 2022

(30) Foreign Application Priority Data
Jul. 18, 2019 (JP) 2019-132399

(51) Int. Cl. G05D 1/02

(52) U.S. Cl. CPC G05D 1/0231; G05D 2201/0207; G05D 1/0274; G05D 1/0219

(57) ABSTRACT

An information processing apparatus of the present disclosure includes: a first acquisition unit that acquires distance information between a measurement target and a distance measurement sensor, which is measured by the distance measurement sensor; a second acquisition unit that acquires position information of a reflector that mirror-reflects a detection target detected by the distance measurement sensor; and an obstacle map creation unit that creates an obstacle map on the basis of the distance information acquired by the first acquisition unit and the position information of the reflector acquired by the second acquisition unit, in which the obstacle map creation unit creates a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

### FIELD

The present disclosure relates to an information processing apparatus, an information processing method, and an information processing program.

### BACKGROUND

In the related art, a technique for detecting an object present in a blind spot area using mirror reflection by a mirror is known. For example, there is provided a technique of detecting an object present in a blind spot area of a crossroad by using an image of the object present in the blind spot area reflected in a reflecting mirror installed on the crossroad.

### CITATION LIST

### Patent Literature

Patent Literature 1: JP 2017-097580 A

Patent Literature 2: JP 2009-116527 A

### SUMMARY

### Technical Problem

According to the related art (for example, Patent Literature 1), there is proposed a method of detecting an object by emitting a measurement wave of a distance measurement sensor to a curved mirror and receiving a reflected wave from the object present in a blind spot area via the curved mirror. In addition, according to the related art (for example, Patent Literature 2), there is proposed a method of detecting an object by detecting an image of the object present in a blind spot area appearing in a curved mirror installed on a crossroad with a camera, and further calculating an approach degree of the object.

However, in the related art, although it is possible to detect an object present in a blind spot area reflected in a mirror and a movement thereof using various sensors using mirror reflection by a mirror, there is a problem that it is difficult to accurately grasp a position of the object in a real world coordinate system. In addition, since the position of the object in the real world coordinate system cannot be accurately grasped, a map of the blind spot area (obstacle map) cannot be appropriately created.

Therefore, the present disclosure proposes an information processing apparatus, an information processing method, and an information processing program capable of detecting an accurate position of an object present in a blind spot area in a real world coordinate system and creating an obstacle map by using an installed object on a route, which performs mirror reflection, such as a curved mirror.

### Solution to Problem

According to the present disclosure, an information processing apparatus includes a first acquisition unit that acquires distance information between a measurement target and a distance measurement sensor, which is measured by the distance measurement sensor; a second acquisition unit that acquires position information of a reflector that mirror-reflects a detection target detected by the distance measurement sensor; and an obstacle map creation unit that creates an obstacle map on the basis of the distance information acquired by the first acquisition unit and the position information of the reflector acquired by the second acquisition unit, wherein the obstacle map creation unit creates a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

### BRIEF DESCRIPTION OF DRAWINGS

FIG. 1 is a diagram illustrating an example of information processing according to a first embodiment of the present disclosure.

FIG. 2 is a diagram illustrating a configuration example of a mobile body device according to the first embodiment.

FIG. 3 is a flowchart illustrating a procedure of information processing according to the first embodiment.

FIG. 4 is a diagram illustrating an example of processing according to a shape of a reflector.

FIG. 5 is a diagram illustrating a configuration example of a mobile body device according to a second embodiment of the present disclosure.

FIG. 6 is a diagram illustrating an example of information processing according to the second embodiment.

FIG. 7 is a flowchart illustrating a procedure of control processing of a mobile body.

FIG. 8 is a diagram illustrating an example of a conceptual diagram of a configuration of a mobile body.

FIG. 9 is a diagram illustrating a configuration example of a mobile body device according to a third embodiment of the present disclosure.

FIG. 10 is a diagram illustrating an example of information processing according to the third embodiment.

FIG. 11 is a diagram illustrating an example of an action plan according to the third embodiment.

FIG. 12 is a diagram illustrating another example of the action plan according to the third embodiment.

FIG. 13 is a flowchart illustrating a procedure of information processing according to the third embodiment.

FIG. 14 is a diagram illustrating an example of a conceptual diagram of a configuration of a mobile body according to the third embodiment.

FIG. 15 is a diagram illustrating a configuration example of a mobile body device according to a fourth embodiment of the present disclosure.

FIG. 16 is a diagram illustrating an example of a threshold information storage unit according to the fourth embodiment.

FIG. 17 is a diagram illustrating an outline of information processing according to the fourth embodiment.

FIG. 18 is a diagram illustrating an outline of information processing according to the fourth embodiment.

FIG. 19 is a diagram illustrating an example of obstacle determination according to the fourth embodiment.

FIG. 20 is a diagram illustrating an example of obstacle determination according to the fourth embodiment.

FIG. 21 is a diagram illustrating an example of obstacle determination according to the fourth embodiment.

FIG. 22 is a diagram illustrating an example of obstacle determination according to the fourth embodiment.

FIG. 23 is a diagram illustrating an example of obstacle determination according to the fourth embodiment.

FIG. 24 is a diagram illustrating an example of obstacle determination according to the fourth embodiment.

FIG. 25 is a diagram illustrating a configuration example of a mobile body device according to a fifth embodiment of the present disclosure.

FIG. 26 is a diagram illustrating an example of information processing according to the fifth embodiment.

FIG. 27 is a diagram illustrating an example of sensor arrangement according to the fifth embodiment.

FIG. 28 is a diagram illustrating an example of obstacle determination according to the fifth embodiment.

FIG. 29 is a diagram illustrating an example of obstacle determination according to the fifth embodiment.

FIG. 30 is a flowchart illustrating a procedure of control processing of a mobile body.

FIG. 31 is a diagram illustrating an example of a conceptual diagram of a configuration of a mobile body.

FIG. 32 is a diagram illustrating a configuration example of an information processing system according to a modification of the present disclosure.

FIG. 33 is a diagram illustrating a configuration example of an information processing apparatus according to a modification of the present disclosure.

FIG. 34 is a block diagram illustrating a configuration example of schematic functions of a mobile body control system to which the present technique can be applied.

FIG. 35 is a hardware configuration diagram illustrating an example of a computer that implements functions of the mobile body device and the information processing apparatus.

### DESCRIPTION OF EMBODIMENTS

Hereinafter, embodiments of the present disclosure will be described in detail with reference to the drawings. Note that the information processing apparatus, the information processing method, and the information processing program according to the present application are not limited by the embodiments. In the following embodiments, the same parts are denoted by the same reference numerals, and redundant description will be omitted.

The present disclosure will be described according to the following item order.

1. First Embodiment

1-1. Outline of information processing according to first embodiment of present disclosure

1-2. Configuration of mobile body device according to first embodiment

1-3. Procedure of information processing according to first embodiment

1-4. Processing example according to shape of reflector

2. Second Embodiment

2-1. Configuration of mobile body device according to second embodiment of present disclosure

2-2. Outline of information processing according to second embodiment

3. Control of mobile body

3-1. Procedure of control processing of mobile body

3-2. Conceptual diagram of configuration of mobile body

4. Third Embodiment

4-1. Configuration of mobile body device according to third embodiment of present disclosure

4-2. Outline of information processing according to third embodiment

4-3. Procedure of information processing according to third embodiment

4-4. Conceptual diagram of configuration of mobile body according to third embodiment

### 5. Fourth Embodiment

5-1. Configuration of mobile body device according to fourth embodiment of present disclosure

5-2. Outline of information processing according to fourth embodiment

5-3. Determination example of obstacle according to fourth embodiment

5-3-1. Determination example of convex obstacle

5-3-2. Determination example of concave obstacle

5-3-3. Determination example of mirror-finished obstacle

6. Fifth Embodiment

6-1. Configuration of mobile body device according to fifth embodiment of present disclosure

6-2. Outline of information processing according to fifth embodiment

6-3. Example of sensor arrangement according to fifth embodiment

6-4. Determination example of obstacle according to fifth embodiment

7. Control of mobile body

7-1. Procedure of control processing of mobile body

7-2. Conceptual diagram of configuration of mobile body

8. Other embodiments

8-1. Other configuration examples

8-2. Configuration of mobile body

8-3. Others

9. Effects according to present disclosure

10. Hardware configuration

### 1. First Embodiment

### 1-1. Outline of Information Processing According to First Embodiment of Present Disclosure

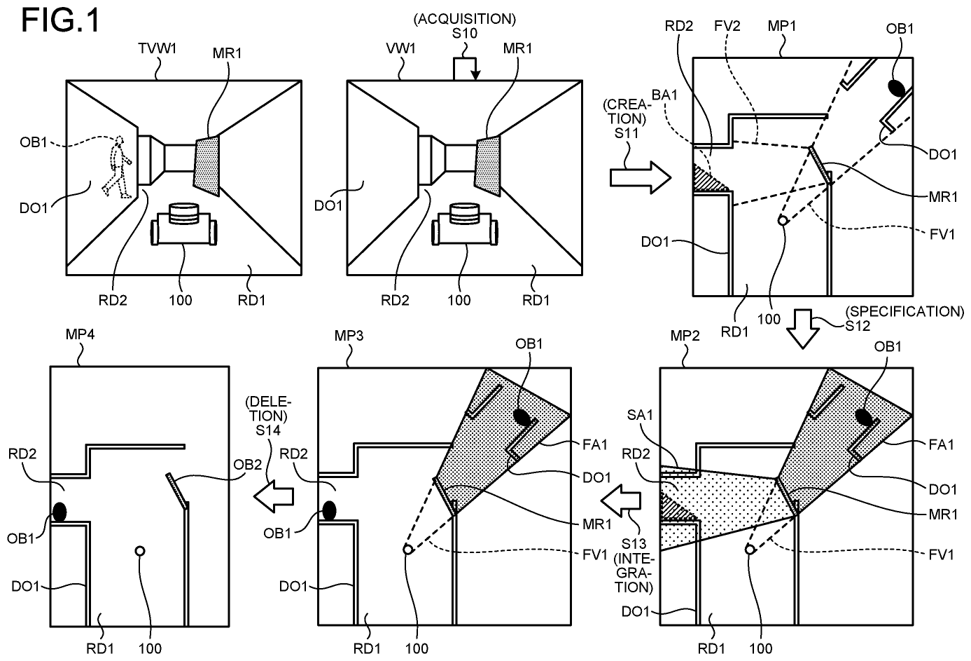

FIG. 1 is a diagram illustrating an example of information processing according to a first embodiment of the present disclosure. The information processing according to the first embodiment of the present disclosure is realized by a mobile body device 100 illustrated in FIG. 1.

The mobile body device 100 is an information processing apparatus that executes information processing according to the first embodiment. The mobile body device 100 is an information processing apparatus that creates an obstacle map on the basis of distance information between a measurement target and a distance measurement sensor 141, which is measured by a distance measurement sensor 141, and position information of a reflector that mirror-reflects a detection target and is detected by the distance measurement sensor 141. For example, the reflector is a concept including a curved mirror or the equivalent thereof. Furthermore, the mobile body device 100 decides an action plan on the basis of the created obstacle map, and moves along the decided action plan. In the example of FIG. 1, an autonomous mobile robot is illustrated as an example of the mobile body device 100, but the mobile body device 100 may be various mobile bodies such as an automobile that travels by automatic driving. Furthermore, in the example of FIG. 1, a case where light detection and ranging or laser imaging detection and ranging (LiDAR) is used as an example of the distance measurement sensor 141 is illustrated. Note that the distance measurement sensor 141 is not limited to LiDAR, and may be various sensors such as a time of flight (ToF) sensor and a stereo camera, but this point will be described later.

FIG. 1 illustrates, as an example, a case where the mobile body device 100 creates a two-dimensional obstacle map in a case where a reflector MR1 that is a mirror is located in the surrounding environment of the mobile body device 100. In the example of FIG. 1, the reflector MR1 is a plane mirror, but may be a convex mirror. In addition, the reflector MR1 is not limited to a mirror, and may be any obstacle as long as the obstacle mirror-reflects the detection target to be detected by the distance measurement sensor 141. That is, in the example of FIG. 1, any obstacle may be used as long as the obstacle mirror-reflects an electromagnetic wave (for example, light) having a frequency in a predetermined range as the detection target to be detected by the distance measurement sensor 141.

Note that the obstacle map created by the mobile body device 100 is not limited to two-dimensional information, and may be three-dimensional information. First, a surrounding situation where the mobile body device 100 is located will be described with reference to a perspective view TVW1. Note that, in the perspective view TVW1 illustrated in FIG. 1, the mobile body device 100 is located on a road RD1, and a depth direction of the perspective view TVW1 is in front of the mobile body device 100. The example of FIG. 1 illustrates a case where the mobile body device 100 travels forward of the mobile body device 100 (in the depth direction of the perspective view TVW1), turns left at a junction of the road RD1 and a road RD2, and travels along the road RD2.

Here, the perspective view TVW1 is a view seeing through a wall DO1 that is the measurement target to be measured by the distance measurement sensor 141, and thus, although illustrated, a person OB1 that is an obstacle that hinders the movement of the mobile body device 100 is located on the road RD2. Furthermore, a visual field diagram VW1 in FIG. 1 is a diagram schematically illustrating a visual field from the position of the mobile body device 100. As illustrated in the visual field diagram VW1, since the wall DO1 is located between the mobile body device 100 and the person OB1, the person OB1 is not a measurement target to be directly measured by the distance measurement sensor 141. Specifically, in the example of FIG. 1, the person OB1 as the obstacle is located in a blind spot area BA1 which is a blind spot from the position of the distance measurement sensor 141. As described above, in the example of FIG. 1, the person OB1 is not directly detected from the position of the mobile body device 100.

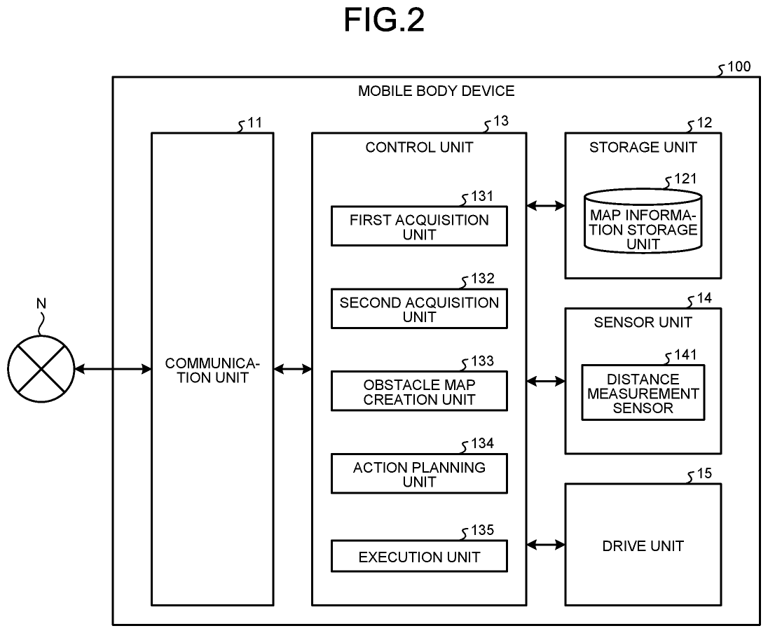

Therefore, the mobile body device 100 creates the obstacle map on the basis of distance information between the measurement target and the distance measurement sensor 141, which is measured by the distance measurement sensor 141, and position information of the reflector that mirror-reflects the detection target and is detected by the distance measurement sensor 141. Note that, the example of FIG. 1 illustrates a case where the reflector MR1 that is a mirror is installed toward the blind spot area BA1 as the blind spot. It is assumed that the mobile body device 100 has acquired the position information of the reflector MR1 in advance. The mobile body device 100 stores the acquired position information of the reflector MR1 in a storage unit 12 (refer to FIG. 2). For example, the mobile body device 100 may acquire the position information of the reflector MR1 from an external information processing apparatus, or may acquire the position information of the reflector MR1 that is a mirror, using various related arts and prior knowledge relating to mirror detection.

First, the mobile body device 100 creates the obstacle map by using the distance information between the measurement target and the distance measurement sensor 141, which is measured by the distance measurement sensor 141 (Step S11). In the example of FIG. 1, the mobile body device 100 creates an obstacle map MP1 by using information detected by the distance measurement sensor 141 that is LiDAR. In this manner, the two-dimensional obstacle map MP1 is constructed using the information of the distance measurement sensor 141 such as LiDAR. As a result, the mobile body device 100 generates the obstacle map MP1 in which a world (environment) that has been reflected by the reflector MR1 is reflected (mapped) on the other side (in a direction away from the mobile body device 100) of the reflector MR1 that is a mirror, and the blind spot area BA1 as the blind spot remains. For example, a first range FV1 in FIG. 1 indicates a visual field from the position of the mobile body device 100 to the reflector MR1, and a second range FV2 in FIG. 1 corresponds to a range reflected in the reflector MR1 in a case where the reflector MR1 is viewed from the position of the mobile body device 100. As described above, in the example of FIG. 1, the second range FV2 includes a part of the wall DO1 and the person OB1 as the obstacle located in the blind spot area BA1.

Next, the mobile body device 100 specifies a first area FA1 created by mirror reflection of the reflector MR1 (Step S12). The mobile body device 100 specifies the first area FA1 in the obstacle map MP1 including the first area FA1 created by mirror reflection of the reflector MR1 on the basis of the position information of the reflector MR1. In the example of FIG. 1, as illustrated in an obstacle map MP2, the mobile body device 100 specifies the first area FA1 in the obstacle map MP2 including the first area FA1 created by mirror reflection of the reflector MR1.

The mobile body device 100 specifies the position of the reflector MR1 by using the acquired position information of the reflector MR1, and specifies the first area FA1 according to the specified position of the reflector MR1. For example, the mobile body device 100 determines (specifies) the first area FA1 corresponding to the back world (the world in the mirror surface) of the reflector MR1 on the basis of the known position of the reflector MR1 and the position of the mobile body device 100 itself. In the example of FIG. 1, the first area FA1 includes a part of the wall DO1 and the person OB1 as the obstacle located in the blind spot area BA1.

In addition, the mobile body device 100 reflects the first area FA1 on the obstacle map as a second area SA1 that is line-symmetric with the first area FA1 at the position of the reflector MR1 that is a mirror. For example, the mobile body device 100 derives the second area SA1 obtained by inverting the first area FA1 with respect to the position of the reflector MR1. The mobile body device 100 creates the second area SA1 by calculating information obtained by inverting the first area FA1 with respect to the position of the reflector MR1.

In the example of FIG. 1, since the reflector MR1 is a plane mirror, the mobile body device 100 creates the second area SA1 that is line-symmetric with the first area FA1 around the position of the reflector MR1 in the obstacle map MP2. Note that the mobile body device 100 may create the second area SA1 that is line-symmetric with the first area FA1 by appropriately using various related arts. For example, the mobile body device 100 may create the second area SA1 using a technique relating to pattern matching such as iterative closest point (ICP), but details will be described later.

Then, the mobile body device 100 integrates the derived second area SA1 into the obstacle map (Step S13). The mobile body device 100 integrates the derived second area SA1 into the obstacle map MP2. In the example of FIG. 1, the mobile body device 100 creates an obstacle map MP3 by adding the second area SA1 to the obstacle map MP2. As described above, the mobile body device 100 creates the obstacle map MP3 indicating that there is no blind spot area BA1 and the person OB1 is located on the road RD2 beyond the wall DO1 from the mobile body device 100. As a result, the mobile body device 100 can grasp that there is a possibility that the person OB1 becomes an obstacle in a case of turning left from the road RD1 to the road RD2.

Then, the mobile body device 100 deletes the first area FA1 from the obstacle map (Step S14). The mobile body device 100 deletes the first area FA1 from the obstacle map MP3. In the example of FIG. 1, the mobile body device 100 creates an obstacle map MP4 by deleting the first area FA1 from the obstacle map MP3. For example, the mobile body device 100 creates the obstacle map MP4 by setting a location corresponding to the first area FA1 as an unknown area. In addition, the mobile body device 100 creates the obstacle map MP4 by setting the position of the reflector MR1 as an obstacle. In the example of FIG. 1, the mobile body device 100 creates the obstacle map MP4 by setting the reflector MR1 as an obstacle OB2.

As described above, the mobile body device 100 creates the obstacle map MP4 in which the second area SA1 obtained by inverting the first area FA1 with respect to the position of the reflector MR1 is integrated. In addition, the mobile body device 100 can generate the obstacle map covering the blind spot by deleting the first area FA1 and setting the position of the reflector MR1 itself as the obstacle. As a result, the mobile body device 100 can grasp the obstacle located in the blind spot, and grasp the position where the reflector MR1 is present as the position where the obstacle is present. As described above, the mobile body device 100 can appropriately create the map even in a case where there is an obstacle that performs mirror reflection.

Then, the mobile body device 100 decides the action plan on the basis of the created obstacle map MP4. In the example of FIG. 1, the mobile body device 100 decides the action plan for turning left so as to avoid the person OB1, on the basis of the obstacle map MP4 indicating that the person OB1 is located at a position where the mobile body device 100 is to turn left. For example, the mobile body device 100 decides the action plan for turning left so as to pass the road RD2 further on the far side than the position of the person OB1. As described above, in the example of FIG. 1, the mobile body device 100 can appropriately create the obstacle map and decide the action plan even in a case where the person OB1 is walking at a left turn destination that is the blind spot in a scene of a left turn. Therefore, since the mobile body device 100 can observe (grasp) beyond the blind spot, the mobile body device 100 enables safe passage by planning a route to avoid the obstacle located in the blind spot directly from the position of the mobile body device 100 or by driving slowly.

For example, when a robot or an automatic driving vehicle performs autonomous movement, it is desirable to consider collision or the like in a case where it is unknown what is ahead after turning a corner. It is desirable to particularly consider a case where a moving object such as a person is beyond the corner. On the other hand, for a human, a mirror or the like is placed at a corner so that the other side (a point after turning the corner) can be seen. The mobile body device 100 illustrated in FIG. 1 acquires information of a point beyond the corner by using a mirror similarly to a human, and reflects the information in the action plan, thereby enabling an action in consideration of the object present in the blind spot.

For example, the mobile body device 100 is an autonomous mobile body that integrates information from various sensors, creates a map, plans an action toward a destination, and controls and moves a device body. The mobile body device 100 is equipped with a distance measurement sensor of an optical system such as LiDAR or a ToF sensor, for example, and executes various kinds of processing as described above. The mobile body device 100 can implement a safer action plan by constructing the obstacle map for the blind spot using the reflector such as a mirror.

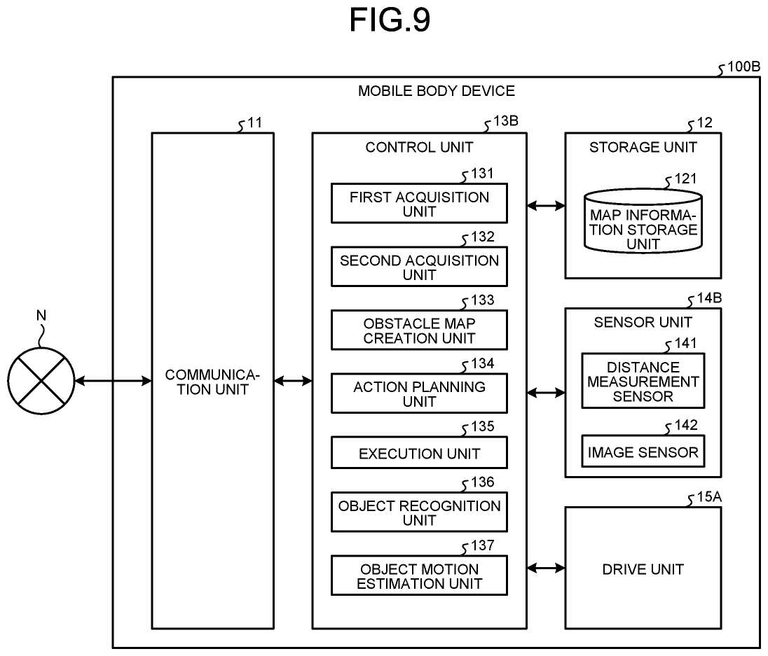

The mobile body device 100 can construct the obstacle map by aligning and combining the information of the distance measurement sensor, which is reflected in the reflector such as a mirror, and the observation result in the real world. Furthermore, the mobile body device 100 can perform an appropriate action plan for the obstacle present in the blind spot by performing the action plan using the constructed map. Note that the mobile body device 100 may detect the position of the reflector such as a mirror using a camera (an image sensor 142 or the like in FIG. 9) or the like, or may have acquired the position as prior knowledge.

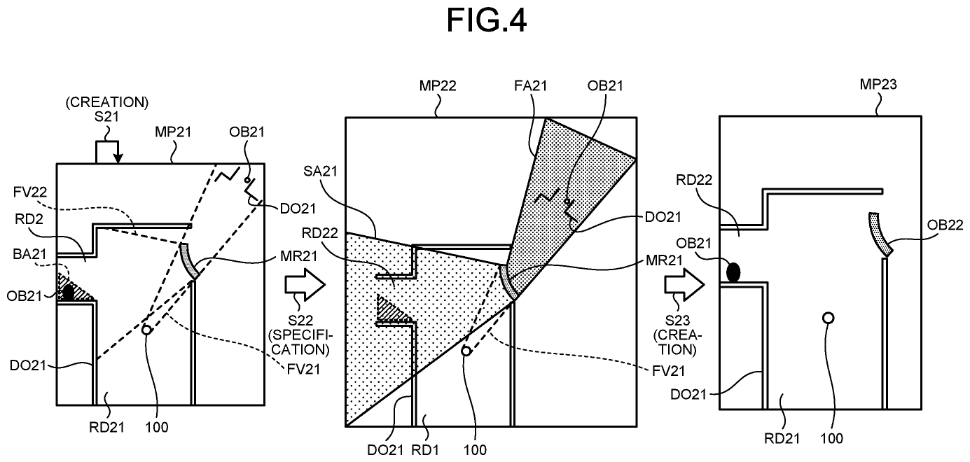

In the example of FIG. 1, the case of the plane mirror has been described as an example, but the mobile body device 100 may perform the above processing on the reflector that is a convex mirror. Although this point will be described in detail in FIG. 4, the mobile body device 100 can construct the obstacle map even in the case of the convex mirror by deriving the second area from the first area according to the curvature or the like of the convex mirror such as a curved mirror. For example, in a case where the information of the curvature of the convex mirror is not acquired, the mobile body device 100 can construct the obstacle map even in the case of the convex mirror by collating the information observed through the reflector such as a mirror while changing the curvature, with the directly observed area. For example, the mobile body device 100 repeatedly collates the information observed through the mirror while changing the curvature with the area that can be directly observed, and adopts the result with the highest collation rate, thereby coping with the curvature of the curved mirror without knowing the curvature in advance. For example, the mobile body device 100 repeatedly collates a first range FV21 in FIG. 4 observed through the mirror while changing the curvature with a second range FV22 in FIG. 4 that can be directly observed, and adopts the result with the highest collation rate, thereby coping with the curvature of the curved mirror without knowing the curvature in advance. In this manner, the mobile body device 100 can cope with the curvature of the curved mirror. For example, the curved mirror is often a convex mirror, and the measurement result reflected by the convex mirror is distorted. The mobile body device 100 can grasp the position and shape of a subject by integrating the second area in consideration of the curvature of the mirror. The mobile body device 100 can correctly grasp the position of the subject even in the case of the convex mirror by collating the real world with the world in the reflector such as a mirror. Note that the mobile body device 100 does not particularly need to know the shape of the mirror, but if the shape is known, a processing speed can be increased. For example, the mobile body device 100 does not need to have acquired the information indicating the shape of the reflector such as a mirror in advance, but the processing speed can be more increased in a case where the information has been acquired. That is, in a case where the curvature of the reflector such as a mirror is known in advance, a step of repeatedly performing collation while changing the curvature can be skipped, and thus, the processing speed of the mobile body device 100 can be increased.

Furthermore, the mobile body device 100 can construct the obstacle map including the blind spot. In this manner, the mobile body device 100 can grasp the position of the subject in the real world by merging the world in the reflector such as a mirror with the map of the real world, and can perform an advanced action plan such as avoidance and stop associated with the position.

### 1-2. Configuration of Mobile Body Device According to First Embodiment

Next, the configuration of the mobile body device 100, which is an example of the information processing apparatus that executes the information processing according to the first embodiment, will be described. FIG. 2 is a diagram illustrating a configuration example of the mobile body device 100 according to the first embodiment.

As illustrated in FIG. 2, the mobile body device 100 includes a communication unit 11, the storage unit 12, a control unit 13, a sensor unit 14, and a drive unit 15.

The communication unit 11 is realized by, for example, a network interface card (NIC), a communication circuit, or the like. The communication unit 11 is connected to a network N (the Internet or the like) in a wired or wireless manner, and transmits and receives information to and from other devices and the like via the network N.

The storage unit 12 is realized by, for example, a semiconductor memory element such as a random access memory (RAM) or a flash memory, or a storage device such as a hard disk or an optical disk. The storage unit 12 includes a map information storage unit 121.

The map information storage unit 121 stores various kinds of information relating to the map. The map information storage unit 121 stores various kinds of information relating to the obstacle map. For example, the map information storage unit 121 stores a two-dimensional obstacle map. For example, the map information storage unit 121 stores information such as obstacle maps MP1 to MP4. For example, the map information storage unit 121 stores a three-dimensional obstacle map. For example, the map information storage unit 121 stores an occupancy grid map.

Note that the storage unit 12 is not limited to the map information storage unit 121, and various kinds of information are stored. The storage unit 12 stores the position information of the reflector that mirror-reflects the detection target detected by the distance measurement sensor 141. For example, the storage unit 12 stores the position information of the reflector such as a mirror. For example, the storage unit 12 may store position information and shape information of the reflector MR1 or the like that is a mirror. For example, in a case where the information of the reflector has been acquired in advance, the storage unit 12 may store the position information and the shape information of the reflector or the like. For example, the storage unit 12 may detect the reflector using a camera, and store the position information and the shape information of the detected reflector or the like.

Returning to FIG. 2, the description will be continued. The control unit 13 is realized by, for example, a central processing unit (CPU), a micro processing unit (MPU), or the like executing a program (for example, the information processing program according to the present disclosure) stored inside the mobile body device 100 using the random access memory (RAM) or the like as a work area. Note that the control unit 13 is a controller, and may be realized by, for example, an integrated circuit such as an application specific integrated circuit (ASIC) or a field programmable gate array (FPGA).

As illustrated in FIG. 2, the control unit 13 includes a first acquisition unit 131, a second acquisition unit 132, an obstacle map creation unit 133, an action planning unit 134, and an execution unit 135, and implements or executes functions and actions of the information processing described below. Note that the internal configuration of the control unit 13 is not limited to the configuration illustrated in FIG. 2, and may be another configuration as long as the information processing to be described later is performed.

The first acquisition unit 131 acquires various kinds of information. The first acquisition unit 131 acquires various kinds of information from an external information processing apparatus. The first acquisition unit 131 acquires various kinds of information from the storage unit 12. The first acquisition unit 131 acquires sensor information detected by the sensor unit 14. The first acquisition unit 131 stores the acquired information in the storage unit 12.

The first acquisition unit 131 acquires the distance information between the measurement target and the distance measurement sensor 141, which is measured by the distance measurement sensor 141. The first acquisition unit 131 acquires the distance information measured by the distance measurement sensor 141 which is an optical sensor. The first acquisition unit 131 acquires the distance information from the distance measurement sensor 141 to the measurement target located in the surrounding environment.

The second acquisition unit 132 acquires various kinds of information. The second acquisition unit 132 acquires various kinds of information from an external information processing apparatus. The second acquisition unit 132 acquires various kinds of information from the storage unit 12. The second acquisition unit 132 acquires sensor information detected by the sensor unit 14. The second acquisition unit 132 stores the acquired information in the storage unit 12.

The second acquisition unit 132 acquires the position information of the reflector that mirror-reflects the detection target detected by the distance measurement sensor 141. The second acquisition unit 132 acquires the position information of the reflector that mirror-reflects the detection target that is an electromagnetic wave detected by the distance measurement sensor 141.

The second acquisition unit 132 acquires the position information of the reflector included in an imaging range imaged by an imaging unit (image sensor or the like). The second acquisition unit 132 acquires the position information of the reflector that is a mirror. The second acquisition unit 132 acquires the position information of the reflector located in the surrounding environment. The second acquisition unit 132 acquires the position information of the reflector located at a junction of at least two roads. The second acquisition unit 132 acquires the position information of the reflector located at an intersection. The second acquisition unit 132 acquires the position information of the reflector that is a curved mirror.

The obstacle map creation unit 133 performs various kinds of generation. The obstacle map creation unit 133 creates (generates) various kinds of information. The obstacle map creation unit 133 generates various kinds of information on the basis of the information acquired by the first acquisition unit 131 and the second acquisition unit 132. The obstacle map creation unit 133 generates various kinds of information on the basis of the information stored in the storage unit 12. The obstacle map creation unit 133 creates map information. The obstacle map creation unit 133 stores the generated information in the storage unit 12. The obstacle map creation unit 133 performs the action plan using various techniques relating to the generation of the obstacle map such as an occupancy grid map.

The obstacle map creation unit 133 specifies a predetermined area in the map information. The obstacle map creation unit 133 specifies an area created by the mirror reflection of the reflector.

The obstacle map creation unit 133 creates the obstacle map on the basis of the distance information acquired by the first acquisition unit 131 and the position information of the reflector acquired by the second acquisition unit 132. In addition, the obstacle map creation unit 133 creates a second obstacle map by specifying the first area in a first obstacle map including the first area created by the mirror reflection of the reflector on the basis of the position information of the reflector, integrating the second area, which is obtained by inverting the specified first area with respect to the position of the reflector, into the first obstacle map, and deleting the first area from the first obstacle map.

The obstacle map creation unit 133 integrates the second area into the first obstacle map by matching feature points of the first area with feature points which correspond to the first area and are measured as the measurement target in the first obstacle map. The obstacle map creation unit 133 creates the obstacle map that is two-dimensional information. The obstacle map creation unit 133 creates the obstacle map that is three-dimensional information. The obstacle map creation unit 133 creates the second obstacle map in which the position of the reflector is set as the obstacle.

The obstacle map creation unit 133 creates the second obstacle map in which the second area obtained by inverting the first area with respect to the position of the reflector is integrated into the first obstacle map, on the basis of the shape of the reflector. The obstacle map creation unit 133 creates the second obstacle map in which the second area obtained by inverting the first area with respect to the position of the reflector is integrated into the first obstacle map, on the basis of the shape of the surface of the reflector facing the distance measurement sensor 141.

The obstacle map creation unit 133 creates the second obstacle map in which the second area including the blind spot area that is the blind spot from the position of the distance measurement sensor 141 is integrated into the first obstacle map. The obstacle map creation unit 133 creates the second obstacle map in which the second area including the blind spot area corresponding to the junction is integrated into the first obstacle map. The obstacle map creation unit 133 creates the second obstacle map in which the second area including the blind spot area corresponding to the intersection is integrated into the first obstacle map.

In the example of FIG. 1, the obstacle map creation unit 133 creates the obstacle map MP1 by using the information detected by the distance measurement sensor 141 that is LiDAR. The obstacle map creation unit 133 specifies the first area FA1 in the obstacle map MP2 including the first area FA1 created by mirror reflection of the reflector MR1. The obstacle map creation unit 133 reflects the first area FA1 on the obstacle map as the second area SA1 that is line-symmetric with the first area FA1 at the position of the reflector MR1 that is a mirror. The obstacle map creation unit 133 creates the second area SA1 that is line-symmetric with the first area FA1 around the position of the reflector MR1 in the obstacle map MP2.

The obstacle map creation unit 133 integrates the derived second area SA1 into the obstacle map MP2. The obstacle map creation unit 133 creates the obstacle map MP3 by adding the second area SA1 to the obstacle map MP2. The obstacle map creation unit 133 deletes the first area FA1 from the obstacle map MP3. The obstacle map creation unit 133 creates the obstacle map MP4 by deleting the first area FA1 from the obstacle map MP3. In addition, the obstacle map creation unit 133 creates the obstacle map MP4 by setting the position of the reflector MR1 as the obstacle. The obstacle map creation unit 133 creates the obstacle map MP4 by setting the reflector MR1 as the obstacle OB2.

The action planning unit 134 makes various plans. The action planning unit 134 generates various kinds of information relating to the action plan. The action planning unit 134 makes various plans on the basis of the information acquired by the first acquisition unit 131 and the second acquisition unit 132. The action planning unit 134 makes various plans using the map information generated by the obstacle map creation unit 133. The action planning unit 134 performs the action plan using various techniques relating to the action plan.

The action planning unit 134 decides the action plan on the basis of the obstacle map created by the obstacle map creation unit 133. The action planning unit 134 decides the action plan for moving so as to avoid the obstacle included in the obstacle map, on the basis of the obstacle map created by the obstacle map creation unit 133.

In the example of FIG. 1, the action planning unit 134 decides the action plan for turning left so as to avoid the person OB1, on the basis of the obstacle map MP4 indicating that the person OB1 is located at the position where the mobile body device 100 is to turn left. The action planning unit 134 decides the action plan for turning left so as to pass the road RD2 further on the far side than the position of the person OB1.

The execution unit 135 executes various kinds of information. The execution unit 135 executes various kinds of processing on the basis of information from an external information processing apparatus. The execution unit 135 executes various kinds of processing on the basis of the information stored in the storage unit 12. The execution unit 135 executes various kinds of information on the basis of the information stored in the map information storage unit 121. The execution unit 135 decides various kinds of information on the basis of the information acquired by the first acquisition unit 131 and the second acquisition unit 132.

The execution unit 135 executes various kinds of processing on the basis of the obstacle map created by the obstacle map creation unit 133. The execution unit 135 executes various kinds of processing on the basis of the action plan planned by the action planning unit 134. The execution unit 135 executes processing relating to an action on the basis of the information of the action plan generated by the action planning unit 134. The execution unit 135 controls the drive unit 15 to execute an action corresponding to the action plan on the basis of the information of the action plan generated by the action planning unit 134. The execution unit 135 executes movement processing of the mobile body device 100 according to the action plan under the control of the drive unit 15 based on the information of the action plan.

The sensor unit 14 detects predetermined information. The sensor unit 14 includes the distance measurement sensor 141.

The distance measurement sensor 141 detects the distance between the measurement target and the distance measurement sensor 141. The distance measurement sensor 141 detects the distance information between the measurement target and the distance measurement sensor 141. The distance measurement sensor 141 may be an optical sensor. In the example of FIG. 1, the distance measurement sensor 141 is LiDAR. The LiDAR detects a distance to a surrounding object and a relative speed by irradiating the surrounding object with a laser beam such as an infrared laser and measuring a time until the laser beam is reflected and returned. Furthermore, the distance measurement sensor 141 may be a distance measurement sensor using a millimeter wave radar. Note that the distance measurement sensor 141 is not limited to LiDAR, and may be various sensors such as a ToF sensor and a stereo camera.

The sensor unit 14 is not limited to the distance measurement sensor 141, and may include various sensors. The sensor unit 14 may include a sensor (the image sensor 142 or the like in FIG. 9) as the imaging unit that captures an image. The sensor unit 14 has a function of an image sensor, and detects image information. The sensor unit 14 may include a sensor (position sensor) that detects position information of the mobile body device 100 such as a global positioning system (GPS) sensor. Note that the sensor unit 14 is not limited to the above, and may include various sensors. The sensor unit 14 may include various sensors such as an acceleration sensor and a gyro sensor. In addition, the sensors that detect the various kinds of information in the sensor unit 14 may be common sensors or may be realized by different sensors.

The drive unit 15 has a function of driving a physical configuration in the mobile body device 100. The drive unit 15 has a function of moving the position of the mobile body device 100. The drive unit 15 is, for example, an actuator. Note that the drive unit 15 may have any configuration as long as the mobile body device 100 can realize a desired operation. The drive unit 15 may have any configuration as long as the drive unit can realize movement of the position of the mobile body device 100 or the like. In a case where the mobile body device 100 includes a moving mechanism such as a caterpillar or a tire, the drive unit 15 drives the caterpillar, the tire, or the like. For example, the drive unit 15 drives the moving mechanism of the mobile body device 100 in accordance with an instruction from the execution unit 135 to move the mobile body device 100, thereby changing the position of the mobile body device 100.

### 1-3. Procedure of Information Processing According to First Embodiment

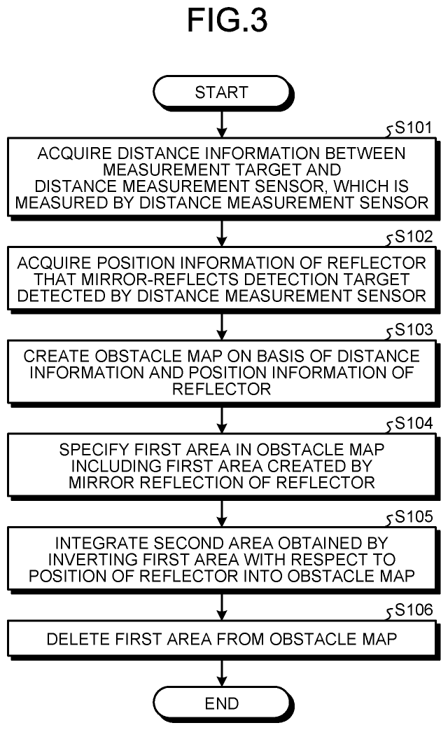

Next, a procedure of information processing according to the first embodiment will be described with reference to FIG. 3. First, a flow of learning processing according to the first embodiment will be described with reference to FIG. 3. FIG. 3 is a flowchart illustrating a procedure of the information processing according to the first embodiment.

As illustrated in FIG. 3, the mobile body device 100 acquires the distance information between the measurement target and the distance measurement sensor 141, which is measured by the distance measurement sensor 141 (Step S101). For example, the mobile body device 100 acquires the distance information from the distance measurement sensor 141 to the measurement target located in the surrounding environment.

The mobile body device 100 acquires the position information of the reflector that mirror-reflects the detection target detected by the distance measurement sensor 141 (Step S102). For example, the mobile body device 100 acquires the position information of the mirror located in the surrounding environment from the distance measurement sensor 141.

Then, the mobile body device 100 creates the obstacle map on the basis of the distance information and the position information of the reflector (Step S103). For example, the mobile body device 100 creates the obstacle map on the basis of the distance information from the distance measurement sensor 141 to the measurement target located in the surrounding environment and the position information of the mirror.

Then, the mobile body device 100 specifies the first area in the obstacle map including the first area created by mirror reflection of the reflector (Step S104). The mobile body device 100 specifies the first area in the first obstacle map including the first area created by mirror reflection of the reflector. For example, the mobile body device 100 specifies the first area in the first obstacle map including the first area created by mirror reflection of the mirror that is located in the surrounding environment.

Then, the mobile body device 100 integrates the second area obtained by inverting the first area with respect to the position of the reflector, into the obstacle map (Step S105). The mobile body device 100 integrates the second area obtained by inverting the first area with respect to the position of the reflector, into the first obstacle map. For example, the mobile body device 100 integrates the second area obtained by inverting the first area with respect to the position of the mirror, into the first obstacle map.

Then, the mobile body device 100 deletes the first area from the obstacle map (Step S106). The mobile body device 100 deletes the first area from the first obstacle map. The mobile body device 100 deletes the first area from the obstacle map, and updates the obstacle map. The mobile body device 100 creates the second obstacle map by deleting the first area from the first obstacle map. For example, the mobile body device 100 deletes the first area from the first obstacle map, and creates the second obstacle map in which the position of the mirror is set as the obstacle.

### 1-4. Processing Example According to Shape of Reflector

In the example of FIG. 1, the case of the plane mirror has been described as an example, but the mobile body device 100 may perform the above processing on the reflector that is a convex mirror. This point will be described with reference to FIG. 4. FIG. 4 is a diagram illustrating an example of processing according to the shape of the reflector. Note that description of the points similar to those in FIG. 1 will be omitted as appropriate.

First, the mobile body device 100 creates the obstacle map by using the distance information between the measurement target and the distance measurement sensor 141, which is measured by the distance measurement sensor 141 (Step S21). In the example of FIG. 4, the mobile body device 100 creates an obstacle map MP21 by using the information detected by the distance measurement sensor 141 that is LiDAR. For example, the first range FV21 in FIG. 4 indicates a visual field from the position of the mobile body device 100 to a reflector MR21, and the second range FV22 in FIG. 4 corresponds to a range reflected in the reflector MR21 in a case where the reflector MR21 is viewed from the position of the mobile body device 100. As described above, in the example of FIG. 4, the second range FV22 includes a part of a wall DO21 and a person OB21 as the obstacle located in a blind spot area BA21.

Next, the mobile body device 100 specifies a first area FA21 created by mirror reflection of the reflector MR21 (Step S22). The mobile body device 100 specifies the first area FA21 in the obstacle map MP21 including the first area FA21 created by mirror reflection of the reflector MR21 on the basis of the position information of the reflector MR21. In the example of FIG. 4, as illustrated in an obstacle map MP22, the mobile body device 100 specifies the first area FA21 in the obstacle map MP22 including the first area FA21 created by mirror reflection of the reflector MR21.

The mobile body device 100 specifies the position of the reflector MR21 by using the acquired position information of the reflector MR21, and specifies the first area FA21 according to the specified position of the reflector MR21. In the example of FIG. 4, the first area FA21 includes a part of the wall DO21 and the person OB21 as the obstacle located in the blind spot area BA21. As described above, in a case where the reflector MR21 is a convex mirror, the reflected world that is observed on the far side of the mirror by the distance measurement sensor 141 is observed in a form of a different scale from the reality.

Here, the mobile body device 100 reflects the first area FA21 on the obstacle map as a second area SA21 obtained by inverting the first area FA21 with respect to the position of the reflector MR21 on the basis of the shape of the reflector MR21. The mobile body device 100 derives the second area SA21 on the basis of the shape of the surface of the reflector MR21 facing the distance measurement sensor 141. It is assumed that the mobile body device 100 has acquired the position information and shape information of the reflector MR21 in advance. For example, the mobile body device 100 acquires the position where the reflector MR21 is installed and information indicating that the reflector MR21 is a convex mirror. The mobile body device 100 acquires information (also referred to as “reflector information”) indicating the size, curvature, and the like of the surface (mirror surface) of the reflector MR21 facing the distance measurement sensor 141.

The mobile body device 100 derives the second area SA21 obtained by inverting the first area FA21 with respect to the position of the reflector MR21 by using the reflector information. The mobile body device 100 determines (specifies) the first area FA21 corresponding to the back world (the world in the mirror surface) of the reflector MR21 from the known position of the reflector MR21 and the position of the mobile body device 100 itself. In the example of FIG. 4, the first area FA21 includes a part of the wall DO21 and the person OB21 as the obstacle located in the blind spot area BA21. Here, a portion other than the blind spot (blind spot area BA21) of the second range FV22 which is estimated to be reflected by the reflector MR21 can be directly observed from an observation point (position of the mobile body device 100). Therefore, the mobile body device 100 derives the second area SA21 by using the information.

For example, the mobile body device 100 derives the second area SA21 by using a technique relating to pattern matching such as ICP. For example, the mobile body device 100 derives the second area SA21 by performing matching between a point group of the second range FV22 directly observed from the position of the mobile body device 100 and a point group of the first area FA21 by using the technique of ICP.

For example, the mobile body device 100 derives the second area SA21 by performing matching between the point group of the second range FV22 other than the blind spot area BA21 that cannot be directly observed from the position of the mobile body device 100 and the point group of the first area FA21. For example, the mobile body device 100 derives the second area SA21 by performing matching between a point group corresponding to the wall DO21 and the road RD2 other than the blind spot area BA21 of the second range FV22 and a point group corresponding to the wall DO21 and the road RD2 in the first area FA21. Note that the mobile body device 100 may derive the second area SA21 by using any information as long as the second area SA21 can be derived without being limited to the ICP described above. For example, the mobile body device 100 may derive the second area SA21 by using a predetermined function that outputs information of an area corresponding to the input information of the area. For example, the mobile body device 100 may derive the second area SA21 by using the information of the first area FA21, the reflector information indicating the size, curvature, and the like of the reflector MR21, and the predetermined function.

Then, the mobile body device 100 creates the obstacle map by integrating the derived second area SA21 into the obstacle map and deleting the first area FA21 from the obstacle map (Step S23). The mobile body device 100 integrates the derived second area SA21 into the obstacle map MP22. In the example of FIG. 4, the mobile body device 100 creates an obstacle map MP23 by adding the second area SA21 to the obstacle map MP22. The mobile body device 100 deletes the first area FA21 from the obstacle map MP22. In the example of FIG. 4, the mobile body device 100 creates the obstacle map MP23 by deleting the first area FA21 from the obstacle map MP22. In addition, the mobile body device 100 creates the obstacle map MP23 by setting the position of the reflector MR21 as the obstacle. In the example of FIG. 4, the mobile body device 100 creates the obstacle map MP23 by setting the reflector MR21 as an obstacle OB22.

As described above, the mobile body device 100 matches the area obtained by inverting the first area FA21 with respect to the position of the reflector MR21 with the area of the second area SA21 by means such as ICP while adjusting the size and distortion. Then, the mobile body device 100 determines and merges a form in which the world in the reflector MR21 is most applicable in reality. In addition, the mobile body device 100 deletes the first area FA21, and fills the position of the reflector MR21 itself as the obstacle OB22. As a result, even in the case of a convex mirror, it is possible to create an obstacle map covering the blind spot. Therefore, the mobile body device 100 can appropriately construct the obstacle map even if the reflector is a reflector having a curvature, such as a convex mirror.

### 2. Second Embodiment

### 2-1. Configuration of Mobile Body Device According to Second Embodiment of Present Disclosure

In the first embodiment, a case where the mobile body device 100 is the autonomous mobile robot is illustrated, but the mobile body device may be an automobile that travels by automatic driving. In a second embodiment, a case where a mobile body device 100A is an automobile that travels by automatic driving will be described as an example. Note that description of the same points as those of the mobile body device 100 according to the first embodiment will be omitted as appropriate.

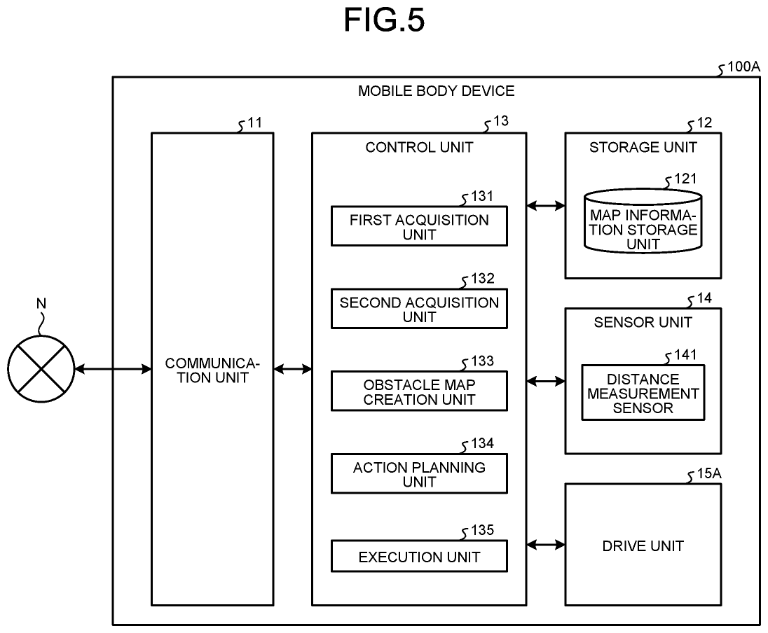

First, the configuration of the mobile body device 100A, which is an example of the information processing apparatus that executes the information processing according to the second embodiment, will be described. FIG. 5 is a diagram illustrating a configuration example of the mobile body device according to the second embodiment of the present disclosure.

As illustrated in FIG. 5, the mobile body device 100A includes the communication unit 11, the storage unit 12, the control unit 13, the sensor unit 14, and a drive unit 15A. For example, the storage unit 12 stores various kinds of information relating to a road or a map on which the mobile body device 100A as an automobile travels. The drive unit 15A has a function of moving the position of the mobile body device 100A which is an automobile. The drive unit 15A is, for example, a motor. The drive unit 15A drives a tire or the like of the mobile body device 100A which is an automobile.

### 2-2. Outline of Information Processing According to Second Embodiment

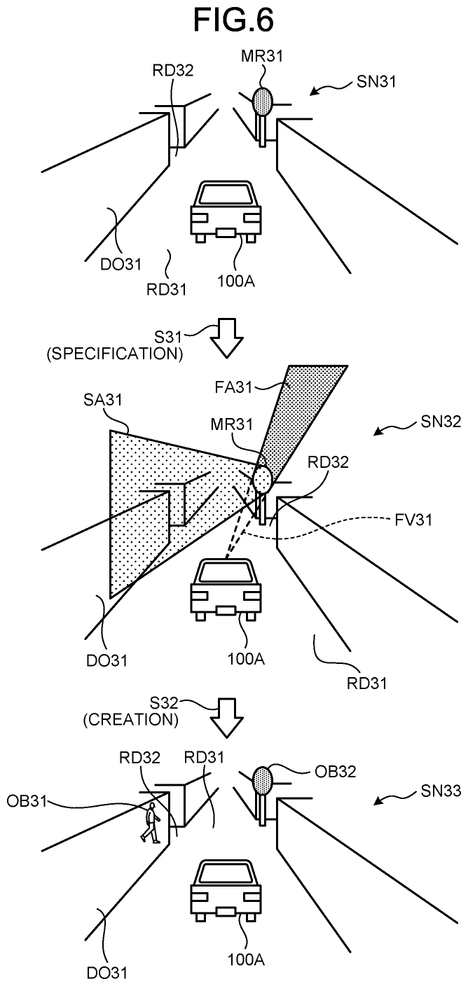

Next, an outline of information processing according to the second embodiment will be described with reference to FIG. 6. FIG. 6 is a diagram illustrating an example of the information processing according to the second embodiment. The information processing according to the second embodiment is realized by the mobile body device 100A illustrated in FIG. 6. FIG. 6 illustrates, as an example, a case where the mobile body device 100A creates a three-dimensional obstacle map in a case where a reflector MR31 that is a curved mirror is located in the surrounding environment of the mobile body device 100A.

Note that the mobile body device 100A appropriately uses various related arts relating to three-dimensional map creation, and the mobile body device 100A creates a three-dimensional obstacle map by using information detected by the distance measurement sensor 141 such as LiDAR. Note that, although a three-dimensional obstacle map is not illustrated in FIG. 6, the mobile body device 100A creates a three-dimensional obstacle map by using the information detected by the distance measurement sensor 141 such as LiDAR. In this case, the distance measurement sensor 141 may be so-called 3D-LiDAR.

In the example of FIG. 6, detection of a person OB31, which is an obstacle located in a blind spot, by the mobile body device 100A will be described using three scenes SN31 to SN33 corresponding to each processing situation. In the scenes SN31 to SN33, the mobile body device 100A is located on a road RD31 that is a road, and the depth direction of the paper surface is in front of the mobile body device 100. In the example of FIG. 6, a case where the reflector MR31 which is a curved mirror is installed at an intersection of the road RD31 and a road RD32 is illustrated.

In the example of FIG. 6, since a wall DO31 is located between the mobile body device 100A and the person OB31, the person OB31 is not a measurement target to be directly measured by the distance measurement sensor 141. Specifically, in the example of FIG. 6, the person OB31 as the obstacle is located in the blind spot area which is the blind spot from the position of the distance measurement sensor 141. As described above, in the example of FIG. 6, the person OB31 is not directly detected from the position of the mobile body device 100A.

First, in the situation illustrated in the scene SN31, the mobile body device 100A creates the obstacle map by using the distance information between the measurement target and the distance measurement sensor 141, which is measured by the distance measurement sensor 141. In the example of FIG. 6, the mobile body device 100A creates the obstacle map by using the information detected by the distance measurement sensor 141 that is 3D-LiDAR.

Next, as illustrated in the scene SN32, the mobile body device 100A specifies a first area FA31 created by mirror reflection of the reflector MR31 (Step S31). For example, a first range FV31 in FIG. 6 indicates a visual field from the position of the mobile body device 100A to the reflector MR31. The mobile body device 100A specifies the first area FA31 in the obstacle map including the first area FA31 created by mirror reflection of the reflector MR31 on the basis of the position information of the reflector MR31.

The mobile body device 100A specifies the position of the reflector MR31 by using the acquired position information of the reflector MR31, and specifies the first area FA31 according to the specified position of the reflector MR31. In the example of FIG. 6, the first area FA31 includes a part of the wall DO31 and the person OB31 as the obstacle located in the blind spot. As described above, in the case of the reflector MR31 which is a three-dimensional space and a convex mirror (a curved mirror on a road), the reflected world that is observed on the far side of the mirror by the distance measurement sensor 141 is observed in a form of a different scale from the reality.

Here, the mobile body device 100A reflects the first area FA31 on the obstacle map as a second area SA31 obtained by inverting the first area FA31 with respect to the position of the reflector MR31 on the basis of the shape of the reflector MR31. The mobile body device 100A derives the second area SA31 on the basis of the shape of the surface of the reflector MR31 facing the distance measurement sensor 141. It is assumed that the mobile body device 100A has acquired the position information and shape information of the reflector MR31 in advance. For example, the mobile body device 100A acquires the position where the reflector MR31 is installed and information indicating that the reflector MR31 is a convex mirror. The mobile body device 100A acquires reflector information indicating the size, curvature, and the like of the surface (mirror surface) of the reflector MR31 facing the distance measurement sensor 141.

The mobile body device 100A derives the second area SA31 obtained by inverting the first area FA31 with respect to the position of the reflector MR31 by using the reflector information. The mobile body device 100A determines (specifies) the first area FA31 corresponding to the back world (the world in the mirror surface) of the reflector MR31 from the known position of the reflector MR31 and the position of the mobile body device 100A itself. In the example of FIG. 6, the first area FA31 includes a part of the wall DO31 and the person OB31 as the obstacle located in the blind spot area. Here, a portion other than the blind spot of the second range which is estimated to be reflected by the reflector MR31 can be directly observed from the observation point (position of the mobile body device 100A). Therefore, the mobile body device 100A derives the second area SA31 by using the information.

For example, the mobile body device 100A derives the second area SA31 by using the technique relating to pattern matching such as ICP. For example, the mobile body device 100A derives the second area SA31 by performing matching between the point group of the second range FV22 directly observed from the position of the mobile body device 100A and the point group of the first area FA31 by using the technique of ICP.

For example, the mobile body device 100A derives the second area SA31 by performing matching between the point group other than the blind spot that cannot be directly observed from the position of the mobile body device 100A and the point group of the first area FA31. For example, the mobile body device 100A derives the second area SA31 by repeating the ICP while changing the curvature. For example, by repeating the ICP while changing the curvature and adopting the result with the highest collation rate, the mobile body device 100 can cope with the curvature of the curved mirror (the reflector MR31 in FIG. 6) without knowing the curvature in advance. For example, the mobile body device 100A derives the second area SA31 by performing matching between the point group corresponding to the wall DO31 and the road RD2 other than the blind spot area of the second range and the point group corresponding to the wall DO31 and the road RD2 in the first area FA31. Note that the mobile body device 100A may derive the second area SA31 by using any information as long as the second area SA31 can be derived without being limited to the ICP described above.

Then, as illustrated in the scene SN32, the mobile body device 100A creates the obstacle map by integrating the derived second area SA31 into the obstacle map and deleting the first area FA31 from the obstacle map (Step S32). The mobile body device 100A integrates the derived second area SA31 into the obstacle map MP22. In the example of FIG. 6, the mobile body device 100A updates the obstacle map by adding the second area SA31 to the obstacle map. The mobile body device 100A deletes the first area FA31 from the obstacle map. In the example of FIG. 6, the mobile body device 100A updates the obstacle map by deleting the first area FA31 from the obstacle map. In addition, the mobile body device 100A creates the obstacle map by setting the position of the reflector MR31 as the obstacle. In the example of FIG. 6, the mobile body device 100A updates the obstacle map by setting the reflector MR31 as an obstacle OB32. As a result, the mobile body device 100A can create a three-dimensional occupancy grid map (obstacle map) covering the blind spot even in the case of a convex mirror.

As described above, the mobile body device 100A matches the area obtained by inverting the first area FA31 with respect to the position of the reflector MR31 with the area of the second area SA31 by means such as ICP while adjusting the size and distortion. Then, the mobile body device 100A determines and merges a form in which the world in the reflector MR31 is most applicable in reality. In addition, the mobile body device 100A deletes the first area FA31, and fills the position of the reflector MR31 itself as the obstacle OB32. As a result, it is possible to create an obstacle map covering the blind spot even in the case of a convex mirror for three-dimensional map information. Therefore, the mobile body device 100A can appropriately construct the obstacle map even if the reflector is a reflector having a curvature, such as a convex mirror.

### 3. Control of Mobile Body

### 3-1. Procedure of Control Processing of Mobile Body

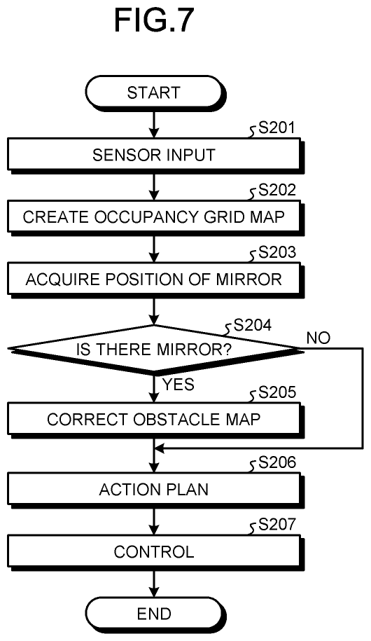

Next, a procedure of control processing of the mobile body will be described with reference to FIG. 7. A detailed flow of movement control processing of the mobile body device 100 and the mobile body device 100A will be described with reference to FIG. 7. FIG. 7 is a flowchart illustrating the procedure of the control processing of the mobile body. Note that, in the following, a case where the mobile body device 100 performs processing will be described as an example, but the processing illustrated in FIG. 7 may be performed by any device of the mobile body device 100 or the mobile body device 100A.

As illustrated in FIG. 7, the mobile body device 100 acquires a sensor input (Step S201). For example, the mobile body device 100 acquires information from a distance sensor such as LiDAR, a ToF sensor, or a stereo camera.

Then, the mobile body device 100 creates the occupancy grid map (Step S202). The mobile body device 100 generates the occupancy grid map that is an obstacle map, by using the information of the obstacle obtained from the sensor on the basis of the sensor input. For example, in a case where there is a mirror in the environment, the mobile body device 100 generates the occupancy grid map including reflection of the mirror. In addition, the mobile body device 100 generates a map in which a blind spot is not observed.

Then, the mobile body device 100 acquires the position of the mirror (Step S203). The mobile body device 100 may acquire the position of the mirror as prior knowledge, or may acquire the position of the mirror by appropriately using various related arts.

Then, the mobile body device 100 determines whether there is a mirror (Step S204). The mobile body device 100 determines whether there is a mirror around. The mobile body device 100 determines whether there is a mirror in a range detected by the distance measurement sensor 141.

In a case where it is determined that there is a mirror (Step S204; Yes), the mobile body device 100 corrects the obstacle map (Step S205). The mobile body device 100 deletes the world in the mirror and complements the blind spot on the basis of the estimated position of the mirror, and creates the occupancy grid map that is an obstacle map.

On the other hand, in a case where it is determined that there is no mirror (Step S204; No), the mobile body device 100 performs the processing of Step S206 without performing the processing of Step S205.

Then, the mobile body device 100 performs the action plan (Step S206). The mobile body device 100 performs the action plan by using the obstacle map. For example, in a case where Step S205 is performed, the mobile body device 100 plans a route on the basis of the corrected map.

Then, the mobile body device 100 performs control (Step S207). The mobile body device 100 performs control on the basis of the decided action plan. The mobile body device 100 controls and moves the device body (own device) so as to follow the plan.

### 3-2. Conceptual Diagram of Configuration of Mobile Body

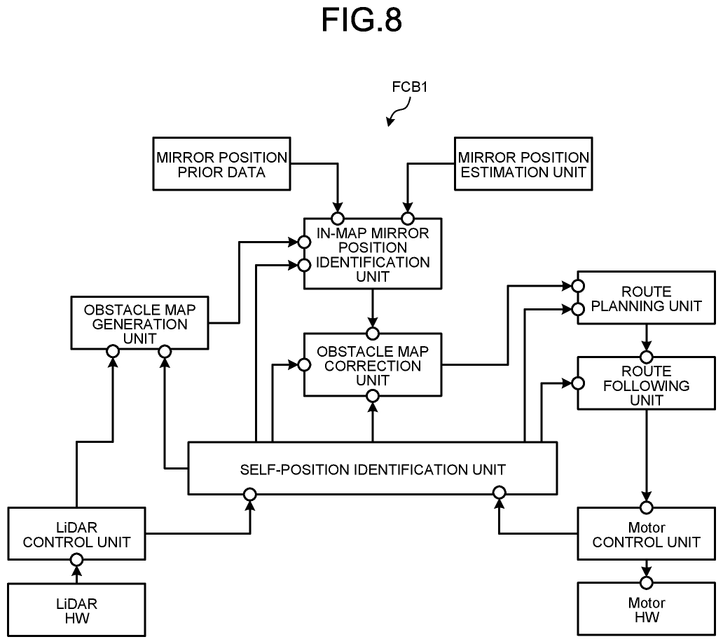

Here, each function, a hardware configuration, and data in the mobile body device 100 and the mobile body device 100A are conceptually illustrated using FIG. 8. FIG. 8 is a diagram illustrating an example of a conceptual diagram of the configuration of the mobile body. A configuration group FCB1 illustrated in FIG. 8 includes a self-position identification unit, a mirror position estimation unit, an in-map mirror position identification unit, an obstacle map generation unit, an obstacle map correction unit, a route planning unit, a route following unit, and the like. In addition, the configuration group FCB1 includes various kinds of information such as mirror position prior data. In addition, the configuration group FCB1 includes a system relating to a distance measurement sensor such as a LiDAR control unit or LiDAR hardware (HW). In addition, the configuration group FCB1 includes a system relating to driving of the mobile body such as a Motor control unit and Motor hardware (HW).

The mirror position prior data corresponds to data in which the position of the mirror measured in advance is stored. The mirror position prior data may not be included in the configuration group FCB1 in a case where there is different means for estimating the position of the detected mirror.

In a case where there is no data in which the position of the mirror measured in advance is stored, the mirror position estimation unit estimates the position of the mirror by any means.

The obstacle map generation unit generates a map of the obstacle on the basis of the information from the distance sensor such as LiDAR. The format of the map generated by the obstacle map generation unit may be various formats such as a simple point cloud, a voxel grid, and an occupancy grid map.

The in-map mirror position identification unit estimates the position of the mirror by using the prior data of the mirror position or the detection result by the mirror estimator, the map received from the obstacle map generation unit, and the self-position. For example, in a case where the position of the mirror is given as absolute coordinates, the self-position is necessary in a case where the obstacle map is updated with reference to the past history. For example, in a case where the position of the mirror is given as absolute coordinates, the mobile body device 100 may acquire the self-position of the mobile body device 100 by GPS or the like.

The obstacle map correction unit receives the mirror position estimated from the mirror position estimation unit and the occupancy grid map, and deletes the world in the mirror that has been mixed in the occupancy grid map. The obstacle map correction unit also fills the position of the mirror itself as the obstacle. The obstacle map correction unit constructs a map excluding the influence of the mirror and the blind spot by merging the world in the mirror with the observation result while correcting distortion.

The route planning unit plans a route to move toward the goal by using the corrected occupancy grid map.

### 4. Third Embodiment

### 4-1. Configuration of Mobile Body Device According to Third Embodiment of Present Disclosure

The information processing apparatus such as the mobile body device may detect an object as the obstacle by using an imaging unit such as a camera. In the third embodiment, a case where object detection is performed using an imaging unit such as a camera will be described as an example. Note that description of the same points as those of the mobile body device 100 according to the first embodiment and the mobile body device 100A according to the second embodiment will be omitted as appropriate.

First, a configuration of a mobile body device 100B, which is an example of the information processing apparatus that executes information processing according to the third embodiment, will be described. FIG. 9 is a diagram illustrating a configuration example of the mobile body device according to the third embodiment of the present disclosure.

As illustrated in FIG. 9, the mobile body device 100B includes the communication unit 11, the storage unit 12, a control unit 13B, a sensor unit 14B, and the drive unit 15A.

Similarly to the control unit 13, the control unit 13B is realized by, for example, a CPU, a MPU, or the like executing a program (for example, the information processing program according to the present disclosure) stored inside the mobile body device 100 using the RAM or the like as a work area. Furthermore, the control unit 13B may be realized by, for example, an integrated circuit such as an ASIC or an FPGA.

As illustrated in FIG. 9, the control unit 13B includes the first acquisition unit 131, the second acquisition unit 132, the obstacle map creation unit 133, the action planning unit 134, the execution unit 135, an object recognition unit 136, and an object motion estimation unit 137, and implements or executes functions and actions of the information processing described below. Note that the internal configuration of the control unit 13B is not limited to the configuration illustrated in FIG. 9, and may be another configuration as long as the information processing to be described later is performed.

The object recognition unit 136 recognizes the object. The object recognition unit 136 recognizes the object by using various kinds of information. The object recognition unit 136 generates various kinds of information relating to a recognition result of the object. The object recognition unit 136 recognizes the object on the basis of the information acquired by the first acquisition unit 131 and the second acquisition unit 132. The object recognition unit 136 recognizes the object by using various kinds of sensor information detected by the sensor unit 14B. The object recognition unit 136 recognizes the object by using image information (sensor information) imaged by the image sensor 142. The object recognition unit 136 recognizes the object included in the image information. The object recognition unit 136 recognizes the object reflected in the reflector imaged by the image sensor 142.

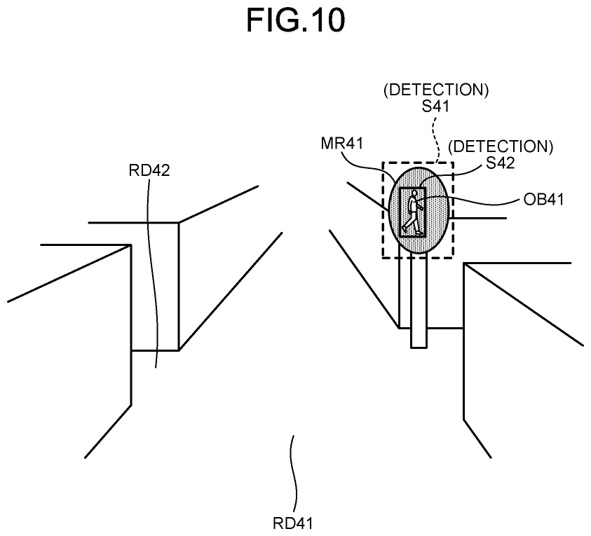

In the example of FIG. 10, the object recognition unit 136 detects a reflector MR41. The object recognition unit 136 detects the reflector MR41 by using the sensor information (image information) detected by the image sensor 142. The object recognition unit 136 detects the reflector included in the image detected by the image sensor 142, by appropriately using various related arts relating to object recognition such as generic object recognition. For example, the object recognition unit 136 detects the reflector MR41, which is a curved mirror, in the image detected by the image sensor 142, by appropriately using various related arts relating to object recognition such as generic object recognition. The object recognition unit 136 detects the reflector MR41, which is a curved mirror, from the image detected by the image sensor 142, by using, for example, a detector or the like in which learning for the curved mirror has been performed.

The object recognition unit 136 detects the object reflected in the reflector MR41. The object recognition unit 136 detects the object reflected in the reflector MR41 by using the sensor information (image information) detected by the image sensor 142. The object recognition unit 136 detects the object reflected in the reflector MR41 included in the image detected by the image sensor 142, by appropriately using various related arts relating to object recognition such as generic object recognition. For example, the object recognition unit 136 detects the object reflected in the reflector MR41, which is a curved mirror, in the image detected by the image sensor 142, by appropriately using various related arts relating to object recognition such as generic object recognition. In the example of FIG. 10, the object recognition unit 136 detects a person OB41 as the obstacle reflected in the reflector MR41. The object recognition unit 136 detects the person OB41 as the obstacle located in the blind spot.

The object motion estimation unit 137 estimates a motion of the object. The object motion estimation unit 137 estimates a motion mode of the object. The object motion estimation unit 137 estimates a motion mode such as that the object is stopped or moving. In a case where the object is moving in position, the object motion estimation unit 137 estimates in which direction the object is moving, how fast the object is moving, and the like.

The object motion estimation unit 137 estimates the motion of the object by using various kinds of information. The object motion estimation unit 137 generates various kinds of information relating to a motion estimation result of the object. The object motion estimation unit 137 estimates the motion of the object on the basis of the information acquired by the first acquisition unit 131 and the second acquisition unit 132. The object motion estimation unit 137 estimates the motion of the object by using various kinds of sensor information detected by the sensor unit 14B. The object motion estimation unit 137 estimates the motion of the object by using the image information (sensor information) imaged by the image sensor 142. The object motion estimation unit 137 estimates the motion of the object included in the image information.

The object motion estimation unit 137 estimates the motion of the object recognized by the object recognition unit 136. The object motion estimation unit 137 detects the moving direction or speed of the object recognized by the object recognition unit 136, on the basis of a change over time of the distance information measured by the distance measurement sensor 141. The object motion estimation unit 137 estimates the motion of the object included in the image detected by the image sensor 142 by appropriately using various related arts relating to the motion estimation of the object.

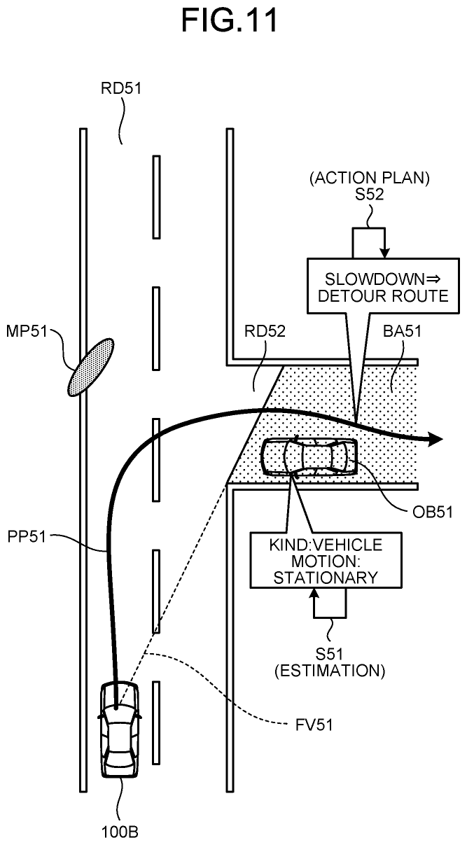

In the example of FIG. 11, the object motion estimation unit 137 estimates a motion mode of a detected automobile OB51. The object motion estimation unit 137 detects the moving direction or speed of the recognized automobile OB51, on the basis of a change over time of the distance information measured by the distance measurement sensor 141. The object motion estimation unit 137 estimates the moving direction or speed of the automobile OB51 on the basis of the change over time of the distance information measured by the distance measurement sensor 141. The object motion estimation unit 137 estimates that the motion mode of the automobile OB51 is a stop mode. For example, the object motion estimation unit 137 estimates that there is no direction of the motion of the automobile OB51 and the speed is zero.

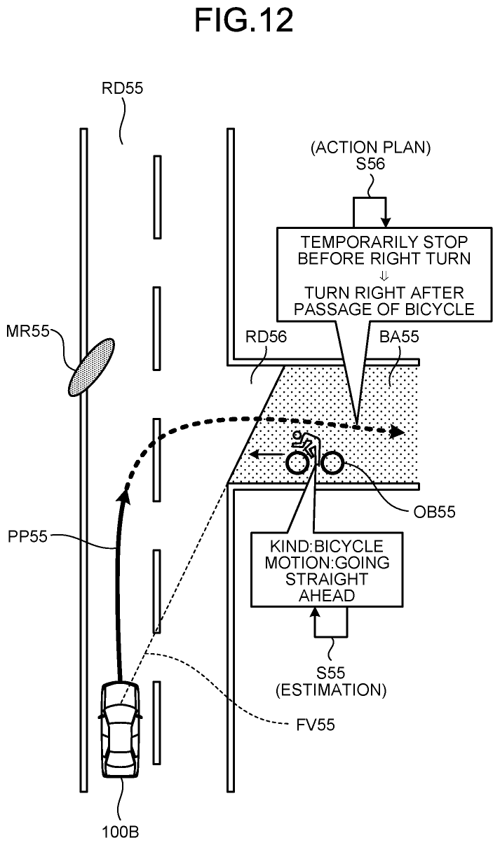

In the example of FIG. 12, the object motion estimation unit 137 estimates a motion mode of a detected bicycle OB55. The object motion estimation unit 137 detects the moving direction or speed of the recognized bicycle OB55, on the basis of a change over time of the distance information measured by the distance measurement sensor 141. The object motion estimation unit 137 estimates the moving direction or speed of the bicycle OB55 on the basis of the change over time of the distance information measured by the distance measurement sensor 141. The object motion estimation unit 137 estimates that the motion mode of the bicycle OB55 is a straight-ahead mode. For example, the object motion estimation unit 137 estimates that the direction of the motion of the bicycle OB55 is straight (direction toward a junction with a road RD55 in FIG. 12).

The sensor unit 14B detects predetermined information. The sensor unit 14B includes the distance measurement sensor 141 and the image sensor 142. The image sensor 142 functions as an imaging unit that captures an image. The image sensor 142 detects image information.

### 4-2. Outline of Information Processing According to Third Embodiment

Next, an outline of the information processing according to the third embodiment will be described with reference to FIG. 10. FIG. 10 is a diagram illustrating an example of the information processing according to the third embodiment. The information processing according to the third embodiment is realized by the mobile body device 100B illustrated in FIG. 9. FIG. 10 illustrates, as an example, a case where the mobile body device 100B detects the obstacle reflected in the reflector MR41 in a case where the reflector MR41 that is a curved mirror is located in the surrounding environment of the mobile body device 100B.

In the example of FIG. 10, the mobile body device 100B (refer to FIG. 9) is located on a road RD41 that is a road, and the depth direction of the paper surface is in front of the mobile body device 100B. In the example of FIG. 10, a case where the reflector MR41 which is a curved mirror is installed at an intersection of the road RD41 and a road RD42 is illustrated. Note that description of the point that the mobile body device 100B creates three-dimensional map information similarly to the mobile body device 100A will be omitted.

First, the mobile body device 100B detects the reflector MR41 (Step S41). The mobile body device 100B detects the reflector MR41 by using the sensor information (image information) detected by the image sensor 142. The mobile body device 100B detects the reflector included in the image detected by the image sensor 142, by appropriately using various related arts relating to object recognition such as generic object recognition. For example, the mobile body device 100B detects the reflector MR41, which is a curved mirror, in the image detected by the image sensor 142, by appropriately using various related arts relating to object recognition such as generic object recognition. The mobile body device 100B may detect the reflector MR41, which is a curved mirror, from the image detected by the image sensor 142, by using, for example, a detector or the like in which learning for the curved mirror has been performed.

As described above, in a case where the mobile body device 100B can use the camera (image sensor 142) in combination, the mobile body device can grasp the position of the mirror by performing the curved mirror detection on the camera image, without knowing the position of the mirror in advance.

Then, the mobile body device 100B detects the object reflected in the reflector MR41 (Step S42). The mobile body device 100B detects the object reflected in the reflector MR41 by using the sensor information (image information) detected by the image sensor 142. The mobile body device 100B detects the object reflected in the reflector MR41 included in the image detected by the image sensor 142, by appropriately using various related arts relating to object recognition such as generic object recognition. For example, the mobile body device 100B detects the object reflected in the reflector MR41, which is a curved mirror, in the image detected by the image sensor 142, by appropriately using various related arts relating to object recognition such as generic object recognition. In the example of FIG. 10, the mobile body device 100B detects the person OB41 as the obstacle reflected in the reflector MR41. The mobile body device 100B detects the person OB41 as the obstacle located in the blind spot.

As described above, the mobile body device 100B can identify what the object reflected in the curved mirror is, by performing generic object recognition on a detection area (within a dotted line in FIG. 10) of the reflector MR41 which is a curved mirror. For example, the mobile body device 100B detects the object such as a person, a car, or a bicycle.

Then, the mobile body device 100B can grasp what kind of object is present in the blind spot, by collating an identification result with a point group of the LiDAR reflected in the world in the mirror. Furthermore, the mobile body device 100B can acquire information relating to the moving direction and speed of the object by tracking the point group collated with the identification result. As a result, the mobile body device 100B can perform a more advanced action plan by using these pieces of information.

Here, an outline of the action plan according to the third embodiment will be described with reference to FIGS. 11 and 12. FIG. 11 is a diagram illustrating an example of the action plan according to the third embodiment. Furthermore, FIG. 12 is a diagram illustrating another example of the action plan according to the third embodiment. FIGS. 11 and 12 are diagrams illustrating examples of an advanced action plan in which a camera (image sensor 142) is combined.

First, an example of FIG. 11 will be described. In the example of FIG. 11, a case where a reflector MR51 which is a curved mirror is installed at an intersection of a road RD51 and a road RD52 is illustrated. In the example illustrated in FIG. 11, the mobile body device 100B is located on the road RD51, and the direction from the mobile body device 100B toward the reflector MR51 is in front of the mobile body device 100B. The example of FIG. 11 illustrates a case where the mobile body device 100B travels forward of the mobile body device 100B, turns left at a junction of the road RD51 and the road RD52, and travels along the road RD52.

For example, a first range FV51 in FIG. 11 indicates a visually recognizable range of the road RD52 from the position of the mobile body device 100B. As described above, in the example of FIG. 11, on the road RD52, a blind spot area BA51 that is a blind spot from the position of the mobile body device 100B is present, and the automobile OB51 that is the obstacle located in the blind spot area BA51 is included.

The mobile body device 100B estimates the kind and motion mode of the object reflected in the reflector MR51 (Step S51). First, the mobile body device 100B detects the object reflected in the reflector MR51. The mobile body device 100B detects the object reflected in the reflector MR51 by using the sensor information (image information) detected by the image sensor 142. In the example of FIG. 11, the mobile body device 100B detects the automobile OB51 as the obstacle reflected in the reflector MR51. The mobile body device 100B detects the automobile OB51 as the obstacle located in the blind spot area BA51 of the road RD52. The mobile body device 100B recognizes the automobile OB51 located in the blind spot area BA51 of the road RD52. As described above, the mobile body device 100B recognizes that the automobile OB51 as the obstacle of which the kind is a “car” is located in the blind spot area BA51 of the road RD52.

Then, the mobile body device 100B estimates the motion mode of the detected automobile OB51. The mobile body device 100B detects the moving direction or speed of the recognized automobile OB51, on the basis of a change over time of the distance information measured by the distance measurement sensor 141. The mobile body device 100B estimates the moving direction or speed of the automobile OB51 on the basis of the change over time of the distance information measured by the distance measurement sensor 141. In the example of FIG. 11, the mobile body device 100B estimates that the motion mode of the automobile OB51 is a stop mode. For example, the mobile body device 100B estimates that there is no direction of the motion of the automobile OB51 and the speed is zero.

Then, the mobile body device 100B decides the action plan (Step S52). The mobile body device 100B decides the action plan on the basis of the detected automobile OB51 or the estimated motion mode of the automobile OB51. Since the automobile OB51 is stopped, the mobile body device 100B decides the action plan to avoid the position of the automobile OB51. Specifically, in a case where the automobile OB51 as the object of which the kind is determined to be a car is detected in the blind spot area BA51 in a stationary state, the mobile body device 100B plans a route PP51 for turning right and detouring to avoid the automobile OB51. In a case where the automobile OB51 as the object of which the kind is determined to be a car is detected in the blind spot area BA51 in a stationary state, the mobile body device 100B plans the route PP51 for approaching the automobile while driving slowly and for turning right and detouring in a case where the automobile is still stationary. In this manner, the mobile body device 100B decides the action plan according to the kind and the motion of the object present in the blind spot by using the camera.

Next, an example of FIG. 12 will be described. In the example of FIG. 12, a case where a reflector MR55 which is a curved mirror is installed at an intersection of the road RD55 and a road RD56 is illustrated. In the example illustrated in FIG. 12, the mobile body device 100B is located on the road RD55, and the direction from the mobile body device 100B toward the reflector MR55 is in front of the mobile body device 100B. The example of FIG. 12 illustrates a case where the mobile body device 100B travels forward of the mobile body device 100B, turns left at a junction of the road RD55 and the road RD56, and travels along the road RD56.

For example, a first range FV55 in FIG. 12 indicates a visually recognizable range of the road RD56 from the position of the mobile body device 100B. As described above, in the example of FIG. 12, on the road RD56, a blind spot area BA55 that is a blind spot from the position of the mobile body device 100B is present, and the bicycle OB55 that is the obstacle located in the blind spot area BA55 is included.

The mobile body device 100B estimates the kind and motion mode of the object reflected in the reflector MR55 (Step S55). First, the mobile body device 100B detects the object reflected in the reflector MR55. The mobile body device 100B detects the object reflected in the reflector MR55 by using the sensor information (image information) detected by the image sensor 142. In the example of FIG. 12, the mobile body device 100B detects the bicycle OB55 as the obstacle reflected in the reflector MR55. The mobile body device 100B detects the bicycle OB55 as the obstacle located in the blind spot area BA55 of the road RD56. The mobile body device 100B recognizes the bicycle OB55 located in the blind spot area BA55 of the road RD56. As described above, the mobile body device 100B recognizes that the bicycle OB55 as the obstacle of which the kind is a “bicycle” is located in the blind spot area BA55 of the road RD56.

Then, the mobile body device 100B estimates the motion mode of the detected bicycle OB55. The mobile body device 100B detects the moving direction or speed of the recognized bicycle OB55, on the basis of a change over time of the distance information measured by the distance measurement sensor 141. The mobile body device 100B estimates the moving direction or speed of the bicycle OB55 on the basis of the change over time of the distance information measured by the distance measurement sensor 141. In the example of FIG. 12, the mobile body device 100B estimates that the motion mode of the bicycle OB55 is a straight-ahead mode. For example, the mobile body device 100B estimates that the direction of the motion of the bicycle OB55 is straight (direction toward the junction with the road RD55 in FIG. 12).

Then, the mobile body device 100B decides the action plan (Step S56). The mobile body device 100B decides the action plan on the basis of the detected bicycle OB55 or the estimated motion mode of the bicycle OB55. The mobile body device 100B decides the action plan to avoid the bicycle OB55 since the bicycle OB55 is moving toward the junction with the road RD55. Specifically, in a case where the bicycle OB55 as the object of which the kind is determined to be a bicycle is detected in the blind spot area BA55 in a straight-ahead motion mode, the mobile body device 100B plans a route PP55 for waiting for the bicycle OB55 to pass and then turning right and passing. In a case where the bicycle OB55 as the object of which the kind is determined to be a bicycle is detected in the blind spot area BA55 in a straight-ahead motion mode, the mobile body device 100B plans the route PP55 for stopping before turning right in consideration of safety, waiting for the bicycle OB55 to pass, and then turning right and passing. In this manner, the mobile body device 100B decides the action plan according to the kind and the motion of the object present in the blind spot by using the camera.

The mobile body device 100B can switch the action plan according to the kind and motion of the object present in the blind spot by using the camera.

### 4-3. Procedure of Information Processing According to Third Embodiment

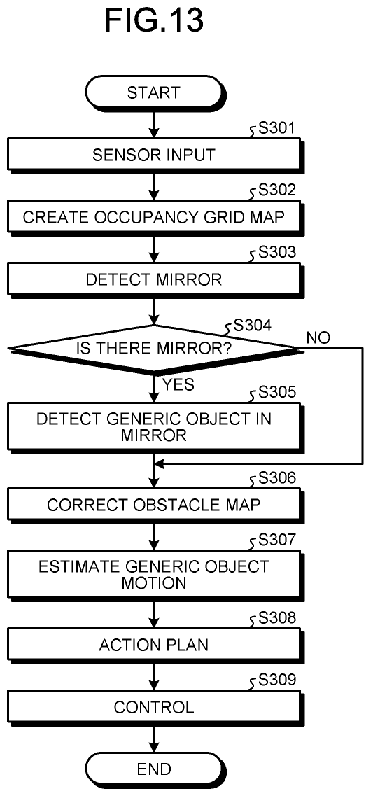

Next, a procedure of control processing of the mobile body will be described with reference to FIG. 13. A detailed flow of movement control processing of the mobile body device 100B will be described with reference to FIG. 13. FIG. 13 is a flowchart illustrating a procedure of the information processing according to the third embodiment.

As illustrated in FIG. 13, the mobile body device 100B acquires the sensor input (Step S301). For example, the mobile body device 100B acquires information from the distance sensor such as LiDAR, a ToF sensor, or a stereo camera.

Then, the mobile body device 100B creates the occupancy grid map (Step S302). The mobile body device 100B generates the occupancy grid map that is an obstacle map, by using the information of the obstacle obtained from the sensor on the basis of the sensor input. For example, in a case where there is a mirror in the environment, the mobile body device 100B generates the occupancy grid map including reflection of the mirror. In addition, the mobile body device 100B generates a map in which a blind spot is not observed.

Then, the mobile body device 100B detects the mirror (Step S303). The mobile body device 100B detects the curved mirror from the camera image by using, for example, a detector or the like in which learning for the curved mirror has been performed.

Then, the mobile body device 100B determines whether there is a mirror (Step S304). The mobile body device 100B determines whether there is a mirror around. The mobile body device 100B determines whether there is a mirror in a range detected by the distance measurement sensor 141.

In a case where it is determined that there is a mirror (Step S304; Yes), the mobile body device 100B detects a generic object in the mirror (Step S305). The mobile body device 100B performs detection on the area of the curved mirror detected in Step S030, by using a recognizer for the generic object such as a person, a car, or a bicycle.

On the other hand, in a case where it is determined that there is no mirror (Step S304; No), the mobile body device 100B performs the processing of Step S306 without performing the processing of Step S305.

The mobile body device 100B corrects the obstacle map (Step S306). The mobile body device 100B deletes the world in the mirror and complements the blind spot on the basis of the estimated position of the mirror, and completes the obstacle map. In addition, the mobile body device 100B records the result as additional information, for the obstacle area where the kind detected in Step S305 is present.

The mobile body device 100B estimates the motion of the generic object (Step S307). The mobile body device 100B estimates the motion of the object by tracking in time series the area where the kind detected in Step S305 is present, on the obstacle map.

Then, the mobile body device 100B performs the action plan (Step S308). The mobile body device 100B performs the action plan by using the obstacle map. For example, the mobile body device 100B plans a route on the basis of the corrected obstacle map. For example, in a case where there is an obstacle in its own traveling direction and the object is a specific kind of object such as a person or a car, the mobile body device 100B switches its action according to the target and the situation.

Then, the mobile body device 100B performs control (Step S309). The mobile body device 100B performs control on the basis of the decided action plan. The mobile body device 100B controls and moves the device body (own device) so as to follow the plan.

### 4-4. Conceptual Diagram of Configuration of Mobile Body According to Third Embodiment

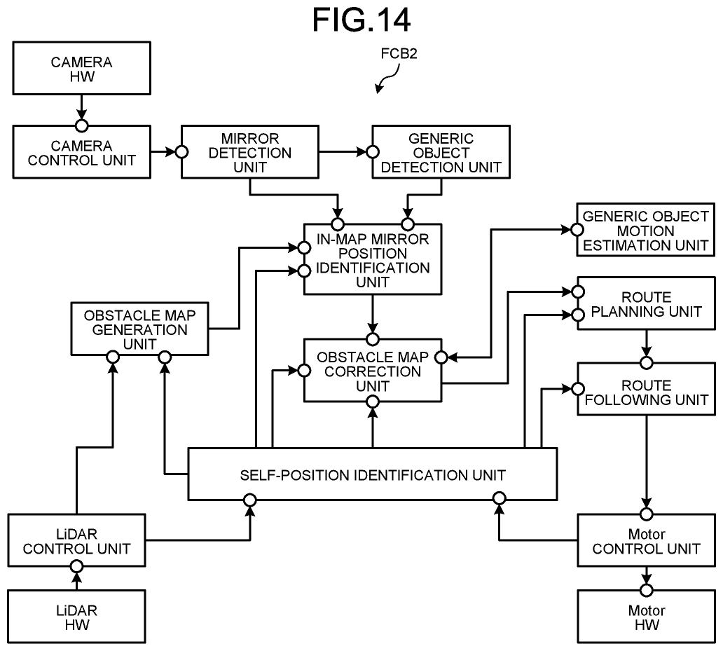

Here, each function, a hardware configuration, and data in the mobile body device 100B are conceptually illustrated using FIG. 14. FIG. 14 is a diagram illustrating an example of a conceptual diagram of the configuration of the mobile body according to the third embodiment. A configuration group FCB2 illustrated in FIG. 14 includes the self-position identification unit, a mirror detection unit, a generic object detection unit, a generic object motion estimation unit, the in-map mirror position identification unit, the obstacle map generation unit, the obstacle map correction unit, the route planning unit, the route following unit, and the like. In addition, the configuration group FCB2 includes a system relating to a distance measurement sensor such as a LiDAR control unit or LiDAR hardware (HW). In addition, the configuration group FCB2 includes a system relating to driving of the mobile body such as a Motor control unit and Motor hardware (HW). In addition, the configuration group FCB2 includes a system related to an imaging unit such as a camera control unit or camera hardware (HW).

The mirror detection unit detects the area of the mirror by using a detector in which learning for the curved mirror or the like has been performed, for example. The generic object detection unit detects the area of the mirror detected by the mirror detection unit, by using a recognizer for the generic object (for example, a person, a car, or a bicycle).

The obstacle map generation unit generates a map of the obstacle on the basis of the information from the distance sensor such as LiDAR. The format of the map generated by the obstacle map generation unit may be various formats such as a simple point cloud, a voxel grid, and an occupancy grid map.

The in-map mirror position identification unit estimates the position of the mirror by using the prior data of the mirror position or the detection result by the mirror estimator, the map received from the obstacle map generation unit, and the self-position.

The obstacle map correction unit receives the mirror position estimated from the mirror position estimation unit and the occupancy grid map, and deletes the world in the mirror that has been mixed in the occupancy grid map. The obstacle map correction unit also fills the position of the mirror itself as the obstacle. The obstacle map correction unit constructs a map excluding the influence of the mirror and the blind spot by merging the world in the mirror with the observation result while correcting distortion. The obstacle map correction unit records the result as additional information for the area where the kind detected by the generic object detection unit is present. The obstacle map correction unit also stores the result for the area in which the motion is estimated by the generic object motion estimation unit.

The generic object motion estimation unit estimates the motion of the object by tracking in time series each area where the kind detected by the generic object detection unit is present, on the obstacle map.

The route planning unit plans a route to move toward the goal by using the corrected occupancy grid map.

### 5. Fourth Embodiment

### 5-1. Configuration of Mobile Body Device According to Fourth Embodiment of Present Disclosure

In a robot or an automatic driving vehicle, obstacle detection by an optical distance measurement sensor such as LiDAR or ToF sensor is generally performed. In a case where such an optical distance measurement sensor is used, when there is an obstacle (reflector) such as a mirror-finished body (mirror or mirror surface metal plate), light is reflected by the surface of the obstacle. Therefore, as described above, there is a problem that an obstacle (reflector) such as a mirror-finished body (mirror or mirror surface metal plate) cannot be detected as the obstacle. For example, when a mirror-finished body is observed from the sensor in a case where obstacle detection is performed by the optical sensor, a world that has been reflected by the mirror-finished body is observed in a certain direction of the mirror-finished body. For this reason, since the mirror itself cannot be observed as the obstacle, there is a possibility of coming into contact with the mirror.

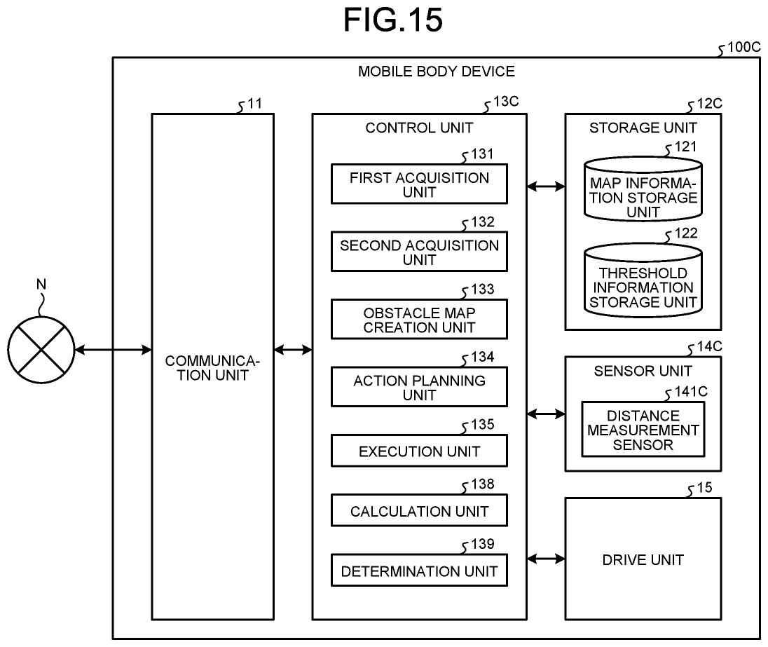

Therefore, the information processing apparatus such as a mobile body device is desired to detect a mirror-finished body as the obstacle even in a case where the mirror-finished body is present, by using an optical distance measurement sensor. In addition, the information processing apparatus such as a mobile body device is desired to appropriately detect not only a reflector such as a mirror-finished body but also an obstacle (convex obstacle) such as an object or a protrusion or an obstacle (concave obstacle) such as a hole or a dent. Therefore, in a mobile body device 100C illustrated in FIG. 15, various obstacles including a reflector are appropriately detected by obstacle determination processing to be described later. The reflector may be various obstacles, for example, a mirror installed at an indoor place such as an elevator or an entrance, or a stainless steel obstacle on a road.

In the fourth embodiment, a case where obstacle detection is performed using a one-dimensional (1D) optical distance sensor will be described as an example. Note that description of the same points as those of the mobile body device 100 according to the first embodiment, the mobile body device 100A according to the second embodiment, and the mobile body device 100B according to the third embodiment will be omitted as appropriate.

First, the configuration of the mobile body device 100C, which is an example of the information processing apparatus that executes the information processing according to the fourth embodiment, will be described. FIG. 15 is a diagram illustrating a configuration example of the mobile body device according to the fourth embodiment of the present disclosure.

As illustrated in FIG. 15, the mobile body device 100C includes the communication unit 11, a storage unit 12C, a control unit 13C, a sensor unit 14C, and the drive unit 15.

The storage unit 12C is realized by, for example, a semiconductor memory element such as a RAM or a flash memory, or a storage device such as a hard disk or an optical disk. The storage unit 12C includes the map information storage unit 121 and a threshold information storage unit 122. The storage unit 12C may store information relating to the shape or the like of the obstacle.

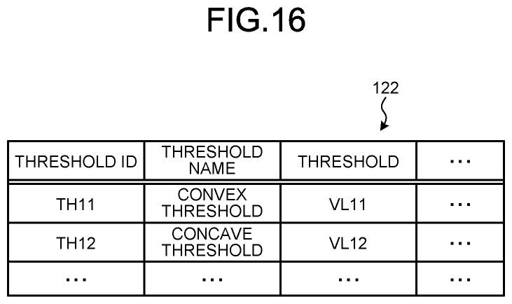

The threshold information storage unit 122 according to the fourth embodiment stores various kinds of information relating to a threshold. For example, the threshold information storage unit 122 stores various kinds of information relating to a threshold used for determination. FIG. 16 is a diagram illustrating an example of the threshold information storage unit according to the fourth embodiment. The threshold information storage unit 122 illustrated in FIG. 16 includes items such as “threshold ID”, “threshold name”, and “threshold”.

The “threshold ID” indicates identification information for identifying the threshold. The “threshold name” indicates a name of a threshold corresponding to the use of the threshold. The “threshold” indicates a specific value of the threshold identified by the corresponding threshold ID. Note that, in the example illustrated in FIG. 16, an abstract code such as “VL11” or “VL12” is illustrated, but in the “threshold”, information indicating a specific value (number) such as “−3”, “−0.5”, “0.8”, or “5” is stored. For example, in the “threshold”, a threshold relating to a distance (meter or the like) is stored.

In the example of FIG. 16, the threshold (threshold TH11) identified by the threshold ID “TH11” indicates that the name is a “convex threshold” and the use is determination for a convex obstacle (for example, an object or a protrusion). The value of the threshold TH11 is “VL11”. For example, the value “VL11” of the threshold TH11 is a predetermined positive value.

In addition, the threshold (threshold TH12) identified by the threshold ID “TH12” indicates that the name is “concave threshold” and the use is determination for a concave obstacle (for example, a hole or a dent). The value of the threshold TH12 is “VL12”. For example, the value “VL12” of the threshold TH12 is a predetermined negative value.

Note that the threshold information storage unit 122 may store various kinds of information depending on the purpose without being limited to the above.

Similarly to the control unit 13, the control unit 13C is realized by, for example, a CPU, a MPU, or the like executing a program (for example, the information processing program according to the present disclosure) stored inside the mobile body device 100 using the RAM or the like as a work area. Furthermore, the control unit 13C may be realized by, for example, an integrated circuit such as an ASIC or an FPGA.

As illustrated in FIG. 15, the control unit 13C includes the first acquisition unit 131, the second acquisition unit 132, the obstacle map creation unit 133, the action planning unit 134, the execution unit 135, a calculation unit 138, and a determination unit 139, and implements or executes functions and actions of the information processing described below. Note that the internal configuration of the control unit 13C is not limited to the configuration illustrated in FIG. 15, and may be another configuration as long as the information processing to be described later is performed.

The calculation unit 138 calculates various kinds of information. The calculation unit 138 calculates various kinds of information on the basis of information acquired from an external information processing apparatus. The calculation unit 138 calculates various kinds of information on the basis of the information stored in the storage unit 12C. The calculation unit 138 calculates various kinds of information by using the information relating to the outer shape of the mobile body device 100C. The calculation unit 138 calculates various kinds of information by using the information relating to the attachment of a distance measurement sensor 141C. The calculation unit 138 calculates various kinds of information by using the information relating to the shape of the obstacle.

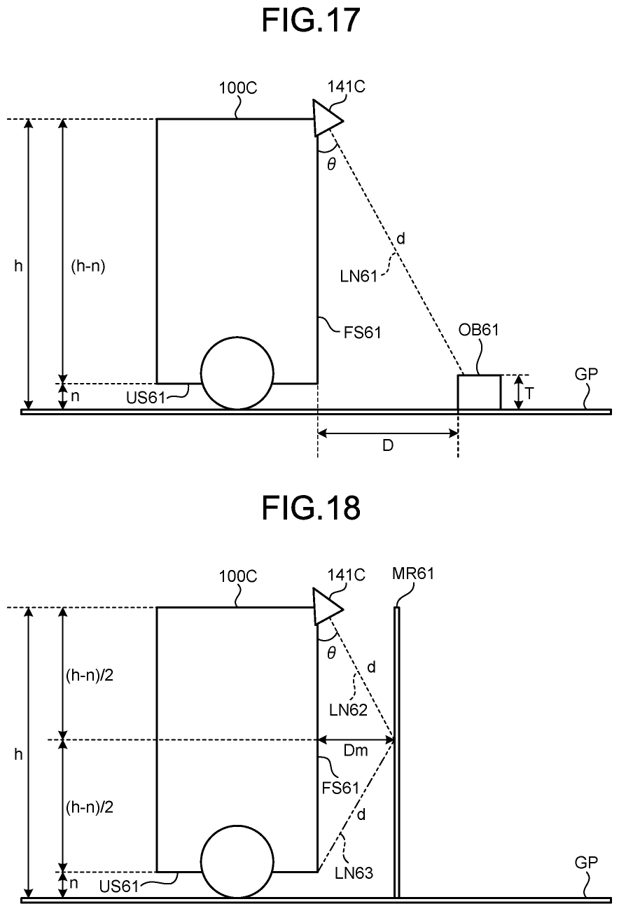

The calculation unit 138 calculates various kinds of information on the basis of the information acquired by the first acquisition unit 131 and the second acquisition unit 132. The calculation unit 138 calculates various kinds of information by using various kinds of sensor information detected by the sensor unit 14C. The calculation unit 138 calculates various kinds of information by using the distance information between the measurement target and the distance measurement sensor 141C, which is measured by the distance measurement sensor 141C. The calculation unit 138 calculates a distance to the measurement target (obstacle) by using the distance information between the obstacle and the distance measurement sensor 141C, which is measured by the distance measurement sensor 141C. The calculation unit 138 calculates various kinds of information as illustrated in FIGS. 17 to 24. For example, the calculation unit 138 calculates various kinds of information such as a value (h-n).

The determination unit 139 determines various kinds of information. The determination unit 139 decides various kinds of information. The determination unit 139 specifies various kinds of information. The determination unit 139 determines various kinds of information on the basis of information acquired from an external information processing apparatus. The determination unit 139 determines various kinds of information on the basis of the information stored in the storage unit 12C.

The determination unit 139 performs various determinations on the basis of the information acquired by the first acquisition unit 131 and the second acquisition unit 132. The determination unit 139 performs various determinations by using various kinds of sensor information detected by the sensor unit 14C. The determination unit 139 performs various determinations by using the distance information between the measurement target and the distance measurement sensor 141C, which is measured by the distance measurement sensor 141C. The determination unit 139 performs a determination relating to the obstacle by using the distance information between the obstacle and the distance measurement sensor 141C, which is measured by the distance measurement sensor 141C. The determination unit 139 performs a determination relating to the obstacle by using the information calculated by the calculation unit 138. The determination unit 139 performs a determination relating to the obstacle by using the information of the distance to the measurement target (obstacle) calculated by the calculation unit 138.

The determination unit 139 performs various determinations as illustrated in FIGS. 17 to 24. For example, the determination unit 139 determines that there is an obstacle OB65, which is a step LD61, on the basis of a comparison between a value (d1−d2) and a convex threshold (the value “VL11” of the threshold TH11).

The sensor unit 14C detects predetermined information. The sensor unit 14C includes the distance measurement sensor 141C. Similarly to the distance measurement sensor 141, the distance measurement sensor 141C detects the distance between the measurement target and the distance measurement sensor 141C. The distance measurement sensor 141C may be a 1D optical distance sensor. The distance measurement sensor 141C may be an optical distance sensor that detects a distance in a one-dimensional direction. The distance measurement sensor 141C may be LiDAR or a 1D ToF sensor.

### 5-2. Outline of Information Processing According to Fourth Embodiment

Next, an outline of the information processing according to the fourth embodiment will be described with reference to FIGS. 17 and 18. FIGS. 17 and 18 are diagrams illustrating examples of the information processing according to the fourth embodiment. The information processing according to the fourth embodiment is realized by the mobile body device 100C illustrated in FIG. 16.

As illustrated in FIGS. 17 and 18, in the mobile body device 100C, the optical distance sensor is attached from the upper portion of the housing of the mobile body device 100C toward the ground. Specifically, in the mobile body device 100C, the distance measurement sensor 141C is attached from the upper portion of a front surface portion FS61 of the mobile body device 100C toward a ground GP. In a case where there is a mirror as the obstacle, the mobile body device 100C detects whether or not there is an obstacle in that direction on the basis of the distance measured by being reflected by the mirror. Note that FIG. 18 illustrates a case where a reflector MR61, which is a mirror, is perpendicular to the ground GP.

Here, the attachment position and angle of the sensor (distance measurement sensor 141C) to (the housing of) the mobile body device 100C are appropriately adjusted toward the ground GP. For example, the attachment position and angle of the sensor (distance measurement sensor 141C) to (the housing of) the mobile body device 100C are appropriately adjusted toward the ground GP by an administrator or the like of the mobile body device 100C. As a result, the distance measurement sensor 141C is installed such that reflected light usually hits the ground GP, but reflected light hits the housing of itself (mobile body device 100C) in a case where the distance to the reflector such as a mirror is sufficiently short. As a result, the mobile body device 100C can determine whether or not there is an obstacle on the basis of the magnitude of the measured distance. Furthermore, since the distance measurement sensor 141C is installed toward the ground GP, in a case where there is a plurality of reflectors such as a mirror in the environment, irregular reflection in which the reflected light is reflected again to another mirror-finished body (reflector) is suppressed.

Here, the distance measurement sensor 141C installed in the mobile body device 100C in FIGS. 17 and 18, a relationship between the distance measurement sensor 141C and the obstacle, and the like will be described. A height h illustrated in FIGS. 17 and 18 indicates the attachment height of the distance measurement sensor 141C. For example, the height h indicates a distance between the upper end of the front surface portion FS61 of the mobile body device 100C, to which the distance measurement sensor 141C is attached, and the ground GP. Furthermore, a height n illustrated in FIGS. 17 and 18 indicates the width of a gap between the housing of the mobile body device 100C and the ground. For example, the height n indicates a distance between a bottom surface portion US61 of the mobile body device 100C and the ground GP. In addition, a value (h−n) illustrated in FIG. 17 indicates the thickness of the housing of the mobile body device 100C in a height direction. In addition, a value (h−n)/2 illustrated in FIG. 18 indicates half the thickness of the housing of the mobile body device 100C in the height direction.

A height T illustrated in FIG. 17 indicates the height of an obstacle OB61. For example, the height T indicates a distance between the upper end of the obstacle OB61 and the ground GP. A distance D illustrated in FIG. 17 indicates a distance between the mobile body device 100C and the obstacle OB61. For example, the distance D indicates a distance from the front surface portion FS61 of the moving body device 100C to a surface of the obstacle OB61 facing the moving body device 100C.

Furthermore, a distance Dm illustrated in FIG. 18 indicates a distance between the mobile body device 100C and the reflector MR61 that is a mirror. For example, the distance Dm indicates a distance from the front surface portion FS61 of the moving body device 100C to a surface of the reflector MR61 facing the moving body device 100C.

An angle θ illustrated in FIGS. 17 and 18 indicates an attachment angle of the distance measurement sensor 141C. For example, the angle θ indicates an angle formed by the front surface portion FS61 of the mobile body device 100C and a normal line (virtual line LN61 or virtual line LN62) of a predetermined surface (for example, a light receiving surface) of the distance measurement sensor 141C.

A distance d illustrated in FIG. 17 indicates a distance between the distance measurement sensor 141C and the obstacle OB61. For example, the distance d illustrated in FIG. 17 indicates a distance from a predetermined surface (for example, a light receiving surface) of the distance measurement sensor 141C to the obstacle OB61. The distance d illustrated in FIG. 17 indicates the length of the virtual line LN61.

The distance d illustrated in FIG. 18 indicates a distance obtained by adding a distance from the distance measurement sensor 141C to the reflector MR61 and a distance from the reflector MR61 to the distance measurement sensor 141C. For example, the distance d illustrated in FIG. 18 indicates a total distance of a distance from a predetermined surface (for example, a light receiving surface) of the distance measurement sensor 141C to the reflector MR61 and a distance from the reflector MR61 to the housing of the distance measurement sensor 141C. The distance d illustrated in FIG. 18 indicates a total value of the length of the virtual line LN62 and the length of a virtual line LN63.

In FIGS. 17 and 18, the distance measurement sensor 141C is attached to the mobile body device 100C while adjusting values such as the distance Dm in the case of closest approach to the reflector such as a mirror, the distance D responding to the obstacle on the ground GP, the height h which is the attachment height of the distance measurement sensor 141C, and the angle θ. For example, in a case where the height h, which is the attachment height of the distance measurement sensor 141C, is determined, when values to be set for the distance D and the distance Dm are decided, the angle θ as the attachment angle of the distance measurement sensor 141C is determined. The distance Dm, the distance D, the height h, and the angle θ may be decided on the basis of various conditions such as the size and moving speed of the mobile body device 100C and the accuracy of the distance measurement sensor 141C.

The mobile body device 100C determines an obstacle by using the information detected by the distance measurement sensor 141C attached as described above. For example, the mobile body device 100C determines an obstacle on the basis of the distance Dm, the distance D, the height h, and the angle θ set as described above.

### 5-3. Determination Example of Obstacle According to Fourth Embodiment

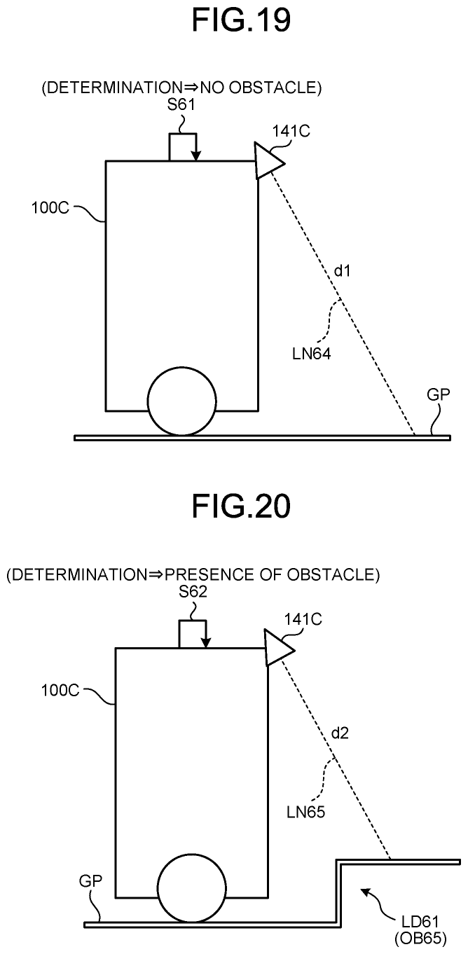

Hereinafter, obstacle determination according to the fourth embodiment will be described with reference to FIGS. 19 to 24. FIGS. 19 to 24 are diagrams illustrating examples of the obstacle determination according to the fourth embodiment. Note that description of the points similar to those in FIGS. 17 and 18 will be omitted as appropriate. In addition, in FIGS. 19 to 24, the distance to the flat ground GP will be described as a distance d1.

First, an example of FIG. 19 will be described. In the example illustrated in FIG. 19, the mobile body device 100C acquires information indicating that the distance from the distance measurement sensor 141C to the measurement target is the distance d1 by the measurement of the distance measurement sensor 141C. As indicated by a virtual line LN64, the mobile body device 100C acquires information indicating that the distance from a predetermined surface (for example, a light receiving surface) of the distance measurement sensor 141C to the measurement target (in this case, the ground GP) is the distance d1.

The mobile body device 100C determines the obstacle by using the measured distance d1 to the measurement target. The mobile body device 100C determines the obstacle by using a predetermined threshold. The mobile body device 100C determines the obstacle by using the convex threshold or the concave threshold. The mobile body device 100C determines the obstacle by using a difference between the distance d1 to the flat ground GP and the measured distance d1 to the measurement target.

The mobile body device 100C determines whether or not there is a convex obstacle on the basis of a comparison between the difference value (d1−d1) and the convex threshold (the value “VL11” of the threshold TH11). For example, in a case where the difference value (d1−d1) is larger than the convex threshold which is a predetermined positive value, the mobile body device 100C determines that there is a convex obstacle. In the example of FIG. 19, since the difference value (d1−d1) is “0” and is smaller than the convex threshold, the mobile body device 100C determines that there is no convex obstacle.

In addition, the mobile body device 100C determines whether or not there is a concave obstacle on the basis of a comparison between the difference value (d1−d1) and the concave threshold (the value “VL12” of the threshold TH12). For example, in a case where the difference value (d1−d1) is smaller than the concave threshold which is a predetermined negative value, the mobile body device 100C determines that there is a concave obstacle. In the example of FIG. 19, since the difference value (d1−d1) is “0” and is larger than the concave threshold, the mobile body device 100C determines that there is no concave obstacle. Accordingly, in the example of FIG. 19, the mobile body device 100C determines that there is no obstacle (Step S61).

### 5-3-1. Determination Example of Convex Obstacle

Next, an example of FIG. 20 will be described. In the example illustrated in FIG. 20, the mobile body device 100C acquires information indicating that the distance from the distance measurement sensor 141C to the measurement target is a distance d2 smaller than the distance d1 by the measurement of the distance measurement sensor 141C. As indicated by a virtual line LN65, the mobile body device 100C acquires information indicating that the distance from a predetermined surface (for example, a light receiving surface) of the distance measurement sensor 141C to the measurement target (the step LD61) is the distance d2.

The mobile body device 100C determines the obstacle by using the measured distance d2 to the measurement target. In a case where the difference value (d1−d2) is larger than the convex threshold, the mobile body device 100C determines that there is a convex obstacle. In the example of FIG. 20, since the difference value (d1−d2) is larger than the convex threshold, the mobile body device 100C determines that there is a convex obstacle (Step S62). The mobile body device 100C determines that there is a convex obstacle OB65 which is the step LD61. As described above, in the example of FIG. 20, in a case where there is a step or an obstacle (ground obstacle) on the ground, the mobile body device 100C determines that there is an obstacle in a case where the value (d1−d2) is larger than the convex threshold, by using the distance d2 to the step or obstacle.

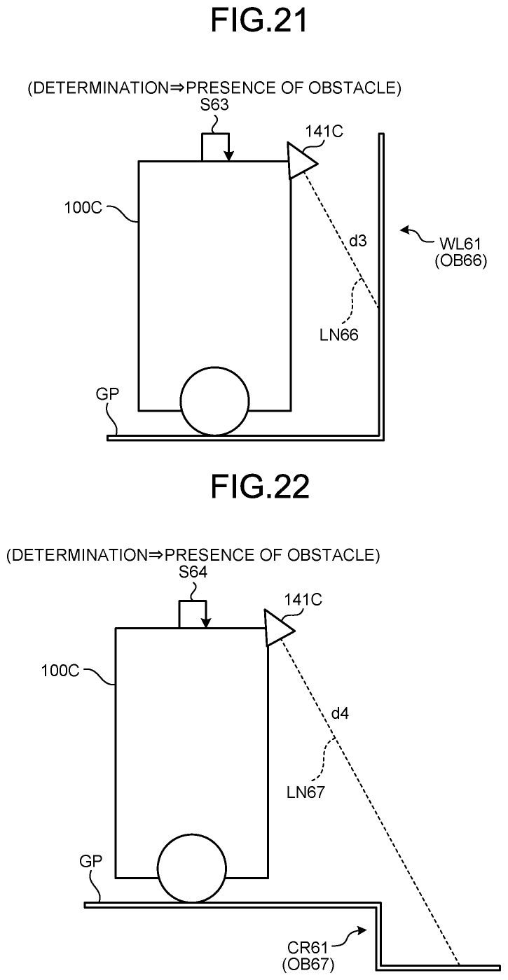

Next, an example of FIG. 21 will be described. In the example illustrated in FIG. 21, the mobile body device 100C acquires information indicating that the distance from the distance measurement sensor 141C to the measurement target is a distance d3 smaller than the distance d1 by the measurement of the distance measurement sensor 141C. As indicated by a virtual line LN66, the mobile body device 100C acquires information indicating that the distance from a predetermined surface (for example, a light receiving surface) of the distance measurement sensor 141C to the measurement target (a wall WL61) is the distance d3.

The mobile body device 100C determines the obstacle by using the measured distance d3 to the measurement target. In a case where the difference value (d1−d3) is larger than the convex threshold, the mobile body device 100C determines that there is a convex obstacle. In the example of FIG. 21, since the difference value (d1−d3) is larger than the convex threshold, the mobile body device 100C determines that there is a convex obstacle (Step S63). The mobile body device 100C determines that there is a convex obstacle OB66 which is the wall WL61. As described above, in the example of FIG. 21, as in the case of the step, the mobile body device 100C determines that there is an obstacle in a case where the value (d1−d3) is larger than the convex threshold, by using the distance d3.

### 5-3-2. Determination Example of Concave Obstacle

Next, an example of FIG. 22 will be described. In the example illustrated in FIG. 22, the mobile body device 100C acquires information indicating that the distance from the distance measurement sensor 141C to the measurement target is a distance d4 larger than the distance d1 by the measurement of the distance measurement sensor 141C. As indicated by a virtual line LN67, the mobile body device 100C acquires information indicating that the distance from a predetermined surface (for example, a light receiving surface) of the distance measurement sensor 141C to the measurement target (a hole CR61) is the distance d4.

In a case where the difference value (d1−d4) is smaller than the concave threshold, the mobile body device 100C determines that there is a concave obstacle. In the example of FIG. 22, since the difference value (d1−d14) is smaller than the concave threshold, the mobile body device 100C determines that there is a concave obstacle (Step S64). The mobile body device 100C determines that there is a concave obstacle OB67 which is the hole CR61. As described above, in the example of FIG. 22, in a case where there is a hole on the ground, the mobile body device 100C determines that there is a hole in a case where the value (d1−d4) is smaller than the concave threshold, by using the distance d4 to the hole. In addition, the mobile body device 100C performs the similar determination even in a case where the distance d4 cannot be acquired. For example, in a case where the distance measurement sensor 141C cannot detect a detection target (for example, an electromagnetic wave such as light), the mobile body device 100C determines that there is a concave obstacle. For example, in a case where the distance measurement sensor 141C cannot acquire the distance information, the mobile body device 100C determines that there is a concave obstacle.

### 5-3-3. Determination Example of Mirror-Finished Obstacle

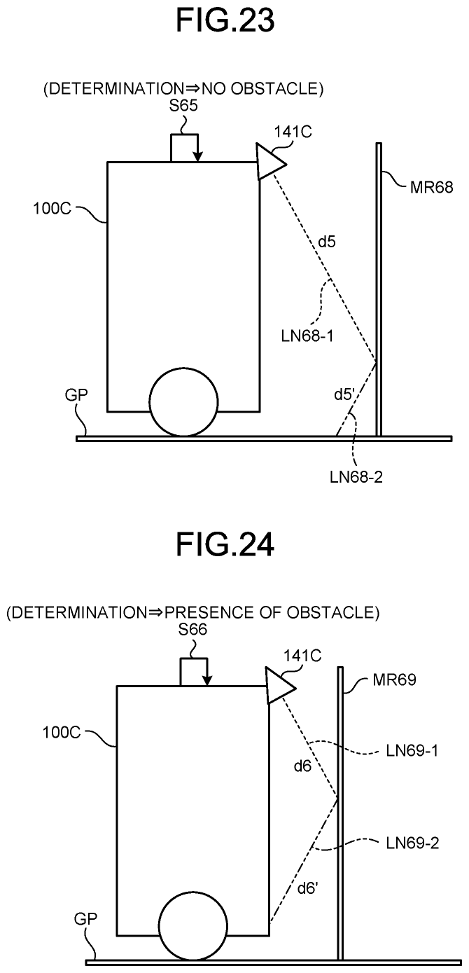

Next, an example of FIG. 23 will be described. In the example illustrated in FIG. 23, the mobile body device 100C acquires information indicating that the distance from the distance measurement sensor 141C to the measurement target is a distance d5+d5′ by the measurement of the distance measurement sensor 141C. As indicated by a virtual line LN68-1 and a virtual line LN68-2, the mobile body device 100C acquires information indicating that the distance from a predetermined surface (for example, a light receiving surface) of the distance measurement sensor 141C to the measurement target (in this case, the ground GP) via a reflector MR68 that is a mirror is the distance d5+d5′. Here, the distance acquired from the distance measurement sensor 141C is d5+d5′, and the magnitude thereof is substantially the same as the distance d1.

The mobile body device 100C determines the obstacle by using the measured distance d5+d5′ to the measurement target. The mobile body device 100C determines the obstacle by using a predetermined threshold. The mobile body device 100C determines the obstacle by using the convex threshold or the concave threshold. The mobile body device 100C determines the obstacle by using a difference between the distance d5+d5′ to the flat ground GP and the measured distance d5+d5′ to the measurement target.

In a case where the difference value (d1−d5+d5′) is larger than the convex threshold, the mobile body device 100C determines that there is a convex obstacle. In the example of FIG. 23, since the difference value (d1−d5+d5′) is substantially “0” and is smaller than the convex threshold, the mobile body device 100C determines that there is no convex obstacle.

Furthermore, in a case where the difference value (d1−d5+d5′) is smaller than the concave threshold, the mobile body device 100C determines that there is a concave obstacle. In the example of FIG. 23, since the difference value (d1−d5+d5′) is substantially “0” and is larger than the concave threshold, the mobile body device 100C determines that there is no concave obstacle. Accordingly, in the example of FIG. 23, the mobile body device 100C determines that there is no obstacle (Step S65). As described above, in a case where there is a reflector such as a mirror far away, the mobile body device 100C is determined to be passable (no obstacle) by the same determination formula as a step, a hole, or the like using the convex threshold or the concave threshold.

Next, an example of FIG. 24 will be described. In the example illustrated in FIG. 24, the mobile body device 100C acquires information indicating that the distance from the distance measurement sensor 141C to the measurement target is a distance d6+d6′ by the measurement of the distance measurement sensor 141C. As indicated by a virtual line LN69-1 and a virtual line LN69-2, the mobile body device 100C acquires information indicating that the distance from a predetermined surface (for example, a light receiving surface) of the distance measurement sensor 141C to the measurement target (in this case, the distance measurement sensor 141C itself) via a reflector MR69 that is a mirror is a distance d6+d6′. Here, the distance acquired from the distance measurement sensor 141C is d6+d6′, and the magnitude thereof is smaller than the distance d1.

The mobile body device 100C determines the obstacle by using the measured distance d6+d6′ to the measurement target. The mobile body device 100C determines the obstacle by using a predetermined threshold. In a case where the difference value (d1−d6+d6′) is larger than the convex threshold, the mobile body device 100C determines that there is a convex obstacle. In the example of FIG. 24, since the difference value (d1−d6+d6′) is larger than the convex threshold, the mobile body device 100C determines that there is a convex obstacle (Step S66). The mobile body device 100C determines that there is the reflector MR69 that is a mirror. As described above, in the example of FIG. 24, since the reflected light hits the own device body in a case where the own device body and the mirror are sufficiently close to each other, the distance d6+d6′ becomes smaller than the distance d1, and therefore, the mobile body device 100C determines that there is an obstacle by the same determination formula as a step or the like using the convex threshold.

As described above, the mobile body device 100C can detect the housing of its own (mobile body device 100C) reflected by the reflector such as a mirror by the distance measurement sensor 141C that is a 1D optical distance sensor, and can detect the obstacle. Furthermore, the mobile body device 100C can detect the unevenness of the ground and the mirror-finished body only by comparing the value detected by the distance sensor (distance measurement sensor 141C) with the threshold. As described above, the mobile body device 100C can simultaneously detect the unevenness of the ground and the mirror-finished body by simple calculation only by determining the magnitude of the value detected by the distance sensor (distance measurement sensor 141C). The mobile body device 100C can collectively detect the convex obstacle, the concave obstacle, the reflector, and the like.

### 6. Fifth Embodiment

### 6-1. Configuration of Mobile Body Device According to Fifth Embodiment of Present Disclosure

In the fourth embodiment, a case where the mobile body device 100 is the autonomous mobile robot is illustrated, but the mobile body device may be an automobile that travels by automatic driving. In a fifth embodiment, a case where a mobile body device 100D is an automobile that travels by automatic driving will be described as an example. Hereinafter, a description will be given on the basis of the mobile body device 100D in which a plurality of distance measurement sensors 141D is arranged over the entire circumference of a vehicle body. Note that description of the same points as those of the mobile body device 100 according to the first embodiment, the mobile body device 100D according to the fifth embodiment, the mobile body device 100B according to the third embodiment, and the mobile body device 100C according to the fourth embodiment will be omitted as appropriate.

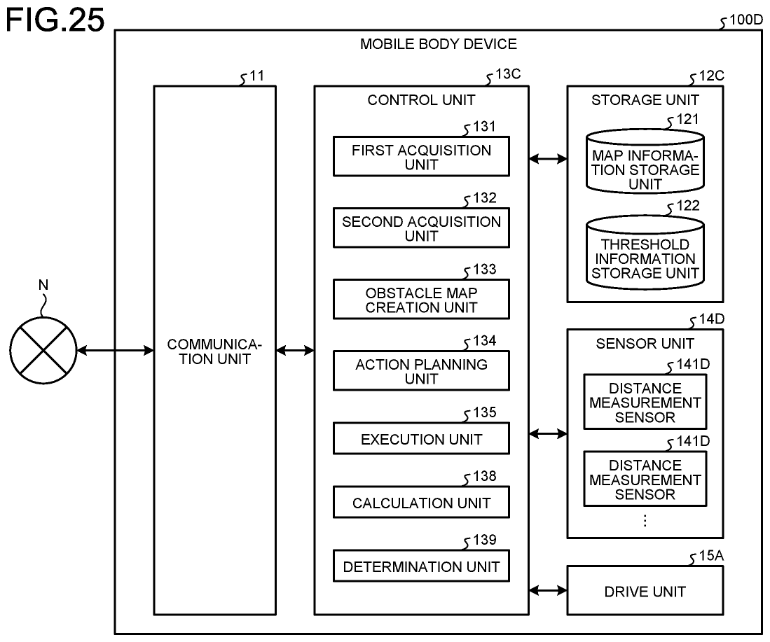

First, the configuration of the mobile body device 100D, which is an example of the information processing apparatus that executes the information processing according to the fifth embodiment, will be described. FIG. 25 is a diagram illustrating a configuration example of the mobile body device according to the fifth embodiment of the present disclosure.

As illustrated in FIG. 25, the mobile body device 100D includes the communication unit 11, the storage unit 12C, the control unit 13C, a sensor unit 14D, and the drive unit 15A.

The sensor unit 14D detects predetermined information. The sensor unit 14D includes the plurality of distance measurement sensors 141D. Similarly to the distance measurement sensor 141, the distance measurement sensor 141D detects the distance between the measurement target and the distance measurement sensor 141. The distance measurement sensor 141D may be a 1D optical distance sensor. The distance measurement sensor 141D may be an optical distance sensor that detects a distance in a one-dimensional direction. The distance measurement sensor 141D may be LiDAR or a 1D ToF sensor. The plurality of distance measurement sensors 141D is arranged at different positions of the vehicle body of the mobile body device 100D. For example, the plurality of distance measurement sensors 141D is arranged at predetermined intervals over the entire circumference of the vehicle body of the mobile body device 100D, but details will be described later.

### 6-2. Outline of Information Processing According to Fifth Embodiment

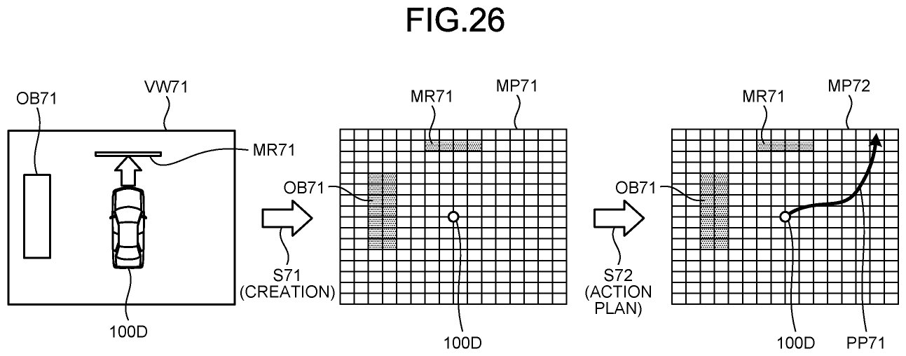

Next, an outline of the information processing according to the fifth embodiment will be described with reference to FIG. 26. FIG. 26 is a diagram illustrating an example of the information processing according to the fifth embodiment. Specifically, FIG. 26 is a diagram illustrating an example of the action plan according to the fifth embodiment. The information processing according to the fifth embodiment is realized by the mobile body device 100D illustrated in FIG. 26. In FIG. 26, illustration of the distance measurement sensor 141D is omitted.

FIG. 26 illustrates a case where an obstacle OB71 and a reflector MR71 are present in the environment around the mobile body device 100D as illustrated in a plan view VW71. Specifically, FIG. 26 illustrates a case where the reflector MR71 is located in front of the mobile body device 100D and the obstacle OB71 is located on the left of the mobile body device 100D.

First, the mobile body device 100D creates the obstacle map by using the distance information between the measurement target and the distance measurement sensor 141D, which is measured by the plurality of distance measurement sensors 141D (Step S71). The mobile body device 100D creates the obstacle map by using the distance information between the measurement target and each distance measurement sensor 141D, which is measured by each of the plurality of distance measurement sensors 141D. In the example of FIG. 26, the mobile body device 100D creates an obstacle map MP71 by using information detected by the plurality of distance measurement sensors 141D which are 1D ToF sensors. Specifically, the mobile body device 100D detects the obstacle OB71 and the reflector MR71, and creates the obstacle map MP71 including the obstacle OB71 and the reflector MR71. The mobile body device 100D creates the obstacle map MP71 which is an occupancy grid map. In this manner, the mobile body device 100D reflects the detected obstacles (a mirror, a hole, and the like) on the occupancy grid map to construct the two-dimensional obstacle map MP71 by using the information of the plurality of distance measurement sensors 141D.

Then, the mobile body device 100D decides the action plan (Step S72). The mobile body device 100D decides the action plan on the basis of the positional relationship with the detected obstacle OB71 and reflector MR71. The mobile body device 100D decides the action plan to move forward while avoiding the contact with the reflector MR71 located in front and the obstacle OB71 located on the left. Specifically, since the reflector MR71 is located in front and the obstacle OB71 is located on the left, the mobile body device 100D decides the action plan to move forward while avoiding the reflector MR71 to the right. The mobile body device 100D plans a route PP71 for moving forward while avoiding the reflector MR71 to the right side. In this manner, since the obstacle OB71 and the reflector MR71 are expressed on the obstacle map MP71 that is the occupancy grid map, the mobile body device 100D can decide the action plan to move forward while avoiding the obstacle OB71 and the reflector MR71.

For the action plan after detection, in a case where it is observed that there is an obstacle, it is possible to perform control to immediately stop in the simplest manner, but the mobile body device 100D can perform more intelligent control (for example, traveling while avoiding collision with the obstacle) than simply stopping by expressing the obstacle on the occupancy grid map.

### 6-3. Example of Sensor Arrangement According to Fifth Embodiment

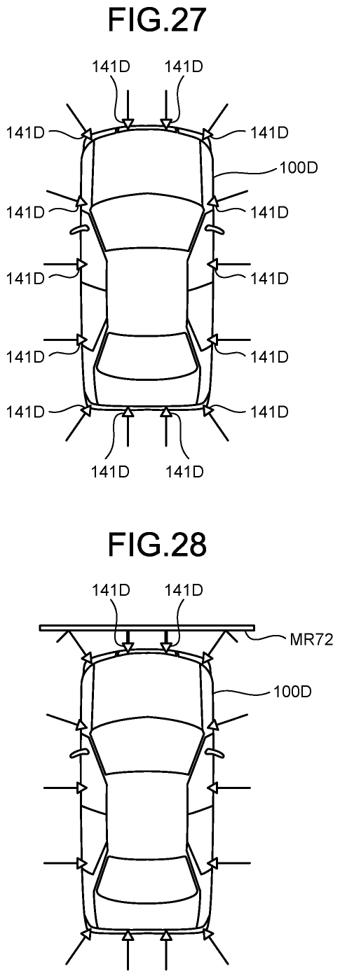

Next, the sensor arrangement according to the fifth embodiment will be described with reference to FIG. 27. FIG. 27 is a diagram illustrating an example of the sensor arrangement according to the fifth embodiment.

As illustrated in FIG. 27, in the mobile body device 100D, the plurality of distance measurement sensors 141D is arranged over the entire circumference of the vehicle body of the mobile body device 100D. Specifically, in the mobile body device 100D, 14 distance measurement sensors 141D are arranged over the entire circumference of the vehicle body.

Two distance measurement sensors 141D are arranged toward the front of the mobile body device 100D, one distance measurement sensor 141D is arranged toward the diagonally right front of the mobile body device 100D, and one distance measurement sensor 141D is arranged toward the diagonally left front of the mobile body device 100D.

In addition, three distance measurement sensors 141D are arranged toward the right of the mobile body device 100D, and three distance measurement sensors 141D are arranged toward the left of the mobile body device 100D. In addition, two distance measurement sensors 141D are arranged toward the rear of the mobile body device 100D, one distance measurement sensor 141D is arranged toward the diagonally right rear of the mobile body device 100D, and one distance measurement sensor 141D is arranged toward the diagonally left rear of the mobile body device 100D. The mobile body device 100D detects the obstacle or creates the obstacle map by using the information detected by the plurality of distance measurement sensors 141D. As described above, in the mobile body device 100D, the distance measurement sensors 141D are installed over the entire circumference of the vehicle body of the mobile body device 100D so as to detect the reflected light of the reflector such as the mirror even in a case where there are reflectors such as mirrors at various angles. In the mobile body device 100D, the optical sensor is installed around the vehicle such that the reflected light of the mirror surface hits the vehicle even in a case where there are mirrors at various angles.

### 6-4. Determination Example of Obstacle According to Fifth Embodiment

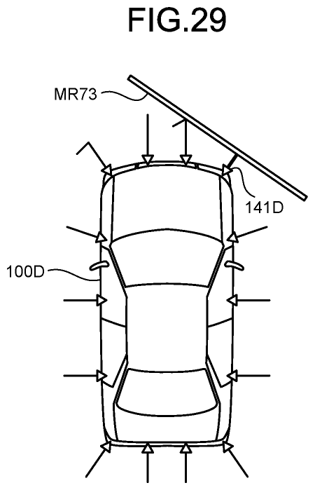

Next, a determination example of the obstacle according to the fifth embodiment will be described with reference to FIGS. 28 and 29. FIGS. 28 and 29 are diagrams illustrating examples of the obstacle determination according to the fifth embodiment.

First, FIG. 28 will be described. FIG. 28 illustrates an example of determination in a case where there is a mirror in front. In FIG. 28, the mobile body device 100D detects a reflector MR72, which is a mirror, by using the information detected by the two distance measurement sensors 141D arranged toward the front of the mobile body device 100D. As described above, in a case where there is a mirror in front, since the reflected light of the two distance measurement sensors 141D arranged toward the front of the mobile body device 100D facing the mirror is detected, the detection distance becomes short, and the mobile body device 100D can determine that there is an obstacle. In a case where there is a mirror in front, it is not detected that there is an obstacle because the reflected light that obliquely hits the mirror directly hits the ground, but the reflected light of the sensor facing the mirror hits the host vehicle so that the detection distance becomes short, and thereby the mobile body device 100D can determine that there is an obstacle.

Next, FIG. 29 will be described. FIG. 29 illustrates an example of determination in a case where there is a mirror diagonally in front. Specifically, FIG. 29 illustrates an example of determination in a case where there is a mirror diagonally forward right. In FIG. 29, the mobile body device 100D detects a reflector MR73, which is a mirror, by using the information detected by one distance measurement sensor 141D arranged toward the diagonally right front of the mobile body device 100D. As described above, in a case where there is a mirror diagonally forward right, since the reflected light of the one distance measurement sensors 141D arranged toward the diagonally right front of the mobile body device 100D facing the mirror is detected, the detection distance becomes short, and the mobile body device 100D can determine that there is an obstacle. It is not detected that there is an obstacle because the reflected light of the front sensor directly hits the ground, but the reflected light of the sensor installed obliquely hits the host vehicle, and thereby the mobile body device 100D determines that there is an obstacle.

### 7. Control of Mobile Body

### 7-1. Procedure of Control Processing of Mobile Body

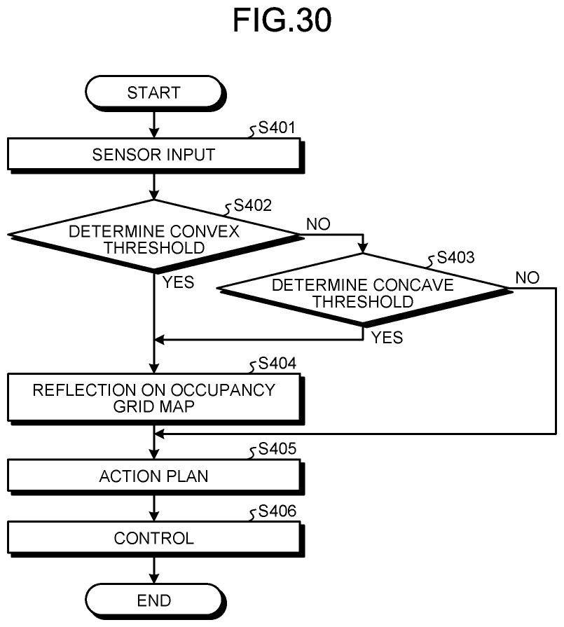

Next, a procedure of control processing of the mobile body will be described with reference to FIG. 30. A detailed flow of movement control processing of the mobile body device 100C and the mobile body device 100D will be described with reference to FIG. 30. FIG. 30 is a flowchart illustrating the procedure of the control processing of the mobile body. Note that, in the following, a case where the mobile body device 100C performs processing will be described as an example, but the processing illustrated in FIG. 30 may be performed by any device of the mobile body device 100C or the mobile body device 100D.

As illustrated in FIG. 30, the mobile body device 100C acquires the sensor input (Step S401). For example, the mobile body device 100C acquires information from the distance sensor such as a 1D ToF sensor or LiDAR.

Then, the mobile body device 100C performs determination relating to the convex threshold (Step S402). The mobile body device 100C determines whether the difference obtained by subtracting the distance to the ground calculated in advance from the input distance of the sensor is sufficiently larger than the convex threshold. As a result, the mobile body device 100C determines whether or not a protrusion, a wall, or the own device body reflected by a mirror is detected on the ground.

In a case where a determination condition relating to the convex threshold is satisfied (Step S402; Yes), the mobile body device 100C reflects the fact on the occupancy grid map (Step S404). The mobile body device 100C corrects the occupancy grid map. For example, in a case where an obstacle or a dent is detected, the mobile body device 100C fills the detected obstacle area on the occupancy grid map with the value of the obstacle.

In a case where the determination condition relating to the convex threshold is not satisfied (Step S402; No), the mobile body device 100C performs determination relating to the concave threshold (Step S403). The mobile body device 100C determines whether the difference obtained by subtracting the distance to the ground calculated in advance from the input distance of the sensor is sufficiently smaller than the concave threshold. As a result, the mobile body device 100C detects a cliff or a dent on the ground.

In a case where the determination condition relating to the concave threshold is satisfied (Step S403; Yes), the mobile body device 100C reflects the fact on the occupancy grid map (Step S404).

In a case where the determination condition relating to the concave threshold is not satisfied (Step S403; No), the mobile body device 100C performs the processing of Step S405 without performing the processing of Step S404.

Then, the mobile body device 100C performs the action plan (Step S405). The mobile body device 100C performs the action plan by using the obstacle map. For example, in a case where Step S404 is performed, the mobile body device 100C plans a route on the basis of the corrected map.

Then, the mobile body device 100C performs control (Step S406). The mobile body device 100C performs control on the basis of the decided action plan. The mobile body device 100C controls and moves the device body (own device) so as to follow the plan.

### 7-2. Conceptual Diagram of Configuration of Mobile Body

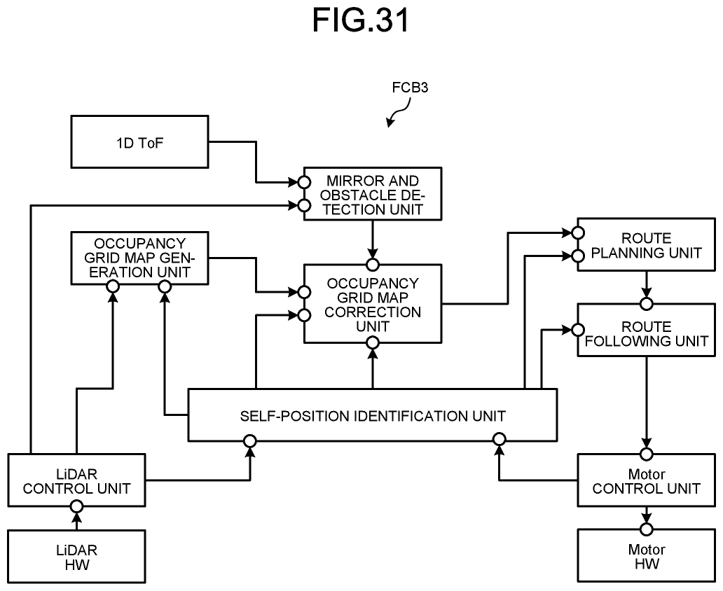

Here, each function, a hardware configuration, and data in the mobile body device 100C and the mobile body device 100D are conceptually illustrated using FIG. 31. FIG. 31 is a diagram illustrating an example of a conceptual diagram of the configuration of the mobile body. A configuration group FCB3 illustrated in FIG. 31 includes a mirror and obstacle detection unit, an occupancy grid map generation unit, an occupancy grid map correction unit, the route planning unit, the route following unit, and the like. In addition, the configuration group FCB3 includes a system relating to a distance measurement sensor such as a LiDAR control unit or LiDAR hardware (HW). In addition, the configuration group FCB3 includes a system relating to driving of the mobile body such as a Motor control unit and Motor hardware (HW). In addition, the configuration group FCB3 includes a distance measurement sensor such as 1DToF.

For example, as illustrated in a configuration group FCB3 illustrated in FIG. 31, the mobile body device 100C generates the obstacle map on the basis of the input from the sensor, plans a route by using the map, and controls a motor so as to follow the last planned route.

The mirror and obstacle detection unit corresponds to an implementation part of an algorithm for detecting the obstacle. The mirror and obstacle detection unit receives an input of the optical distance measurement sensor such as a 1D ToF sensor or LiDAR as an input, and makes a determination on the basis of the information. It is sufficient that there is at least one input. The mirror and obstacle detection unit observes an input distance of the sensor, and detects whether a protrusion, a wall, or the own device reflected by a mirror is detected on the ground, a cliff, or a dent on the ground. The mirror and obstacle detection unit transmits the detection result to the occupancy grid map correction unit.

The occupancy grid map correction unit receives the position of the obstacle received from the mirror and obstacle detection unit and the occupancy grid map generated by the output of the LiDAR, and reflects the obstacle on the occupancy grid map.

The route planning unit plans a route to move toward the goal by using the corrected occupancy grid map.

### 8. Other Embodiments

The processing according to each embodiment described above may be performed in various different forms (modifications) other than each embodiment described above.

### 8-1. Other Configuration Examples

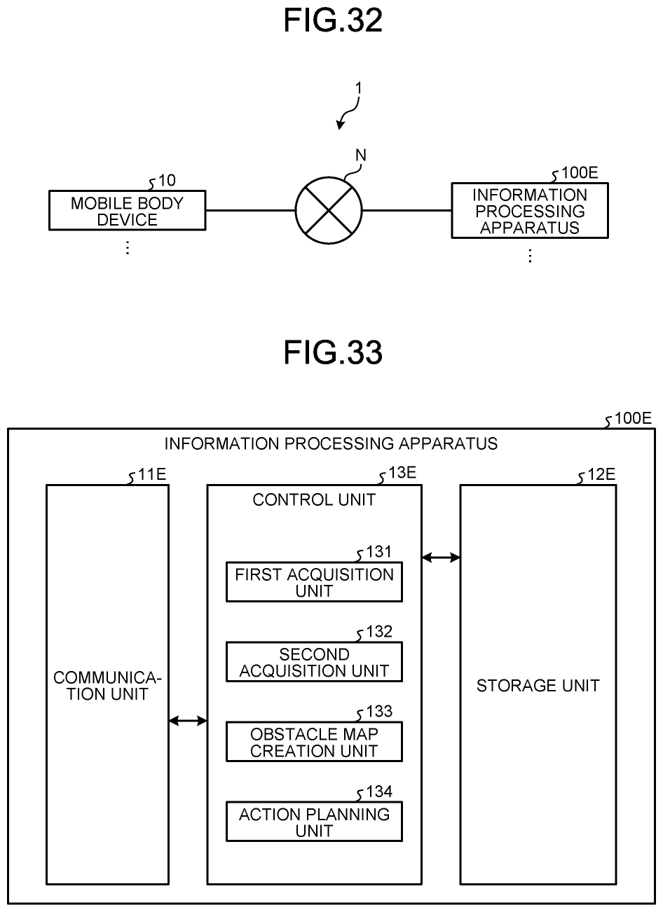

For example, in the examples described above, an example has been described in which the information processing apparatus performing the information processing is the mobile body devices 100, 100A to 100D, but the information processing apparatus and the mobile body device may be separate bodies. This point will be described with reference to FIGS. 32 and 33. FIG. 32 is a diagram illustrating a configuration example of an information processing system according to a modification of the present disclosure. FIG. 33 is a diagram illustrating a configuration example of an information processing apparatus according to the modification of the present disclosure.

As illustrated in FIG. 32, an information processing system 1 includes a mobile body device 10 and an information processing apparatus 100E. The mobile body device 10 and the information processing apparatus 100E are communicably connected in a wired or wireless manner via the network N. Note that the information processing system 1 illustrated in FIG. 32 may include a plurality of mobile body devices 10 and a plurality of information processing apparatuses 100E. In this case, the information processing apparatus 100E may communicate with the mobile body device 10 via the network N, and give an instruction to control the mobile body device 10 on the basis of information collected by the mobile body device 10 and various sensors.

The mobile body device 10 transmits sensor information detected by the sensor such as a distance measurement sensor to the information processing apparatus 100E. The mobile body device 10 transmits distance information between the measurement target and the distance measurement sensor, which is measured by the distance measurement sensor, to the information processing apparatus 100E. As a result, the information processing apparatus 100E acquires the distance information between the measurement target and the distance measurement sensor, which is measured by the distance measurement sensor. The mobile body device 10 may be any device as long as the device can transmit and receive information to and from the information processing apparatus 100E, and may be, for example, various mobile bodies such as an autonomous mobile robot and an automobile that travels by automatic driving.

The information processing apparatus 100E is an information processing apparatus that provides, to the mobile body device 10, the information for controlling the mobile body device 10, such as information of the detected obstacle, the created obstacle map, and the action plan. For example, the information processing apparatus 100E creates the obstacle map on the basis of the distance information and the position information of the reflector. The information processing apparatus 100E decides the action plan on the basis of the obstacle map, and transmits information of the decided action plan to the mobile body device 10. The mobile body device 10 that has received the information of the action plan from the information processing apparatus 100E performs control and moves on the basis of the information of the action plan.

As illustrated in FIG. 33, the information processing apparatus 100E includes a communication unit 11E, a storage unit 12E, and a control unit 13E. The communication unit 11E is connected to the network N (the Internet or the like) in a wired or wireless manner, and transmits and receives information to and from the mobile body device 10 via the network N. The storage unit 12E stores information for controlling the movement of the mobile body device 10, various kinds of information received from the mobile body device 10, and various kinds of information to be transmitted to the mobile body device 10. The control unit 13E does not include the execution unit 135. As described above, the information processing apparatus 100E may not include a sensor unit, a drive unit, or the like, and may not have a configuration for realizing the function as the mobile body device. Note that the information processing apparatus 100E may include an input unit (for example, a keyboard, a mouse, or the like) that receives various operations from an administrator or the like who manages the information processing apparatus 100E, and a display unit (for example, a liquid crystal display or the like) for displaying various kinds of information.

### 8-2. Configuration of Mobile Body

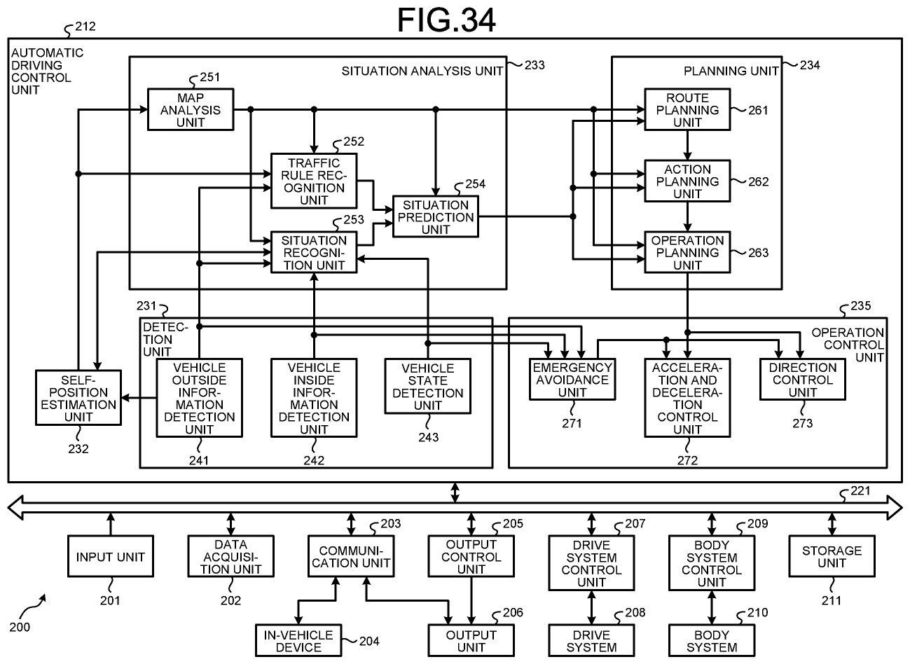

Furthermore, the mobile body devices 100, 100A, 100B, 100C, and 100D and the information processing apparatus 100E described above may have a configuration as illustrated in FIG. 34. For example, the mobile body device 100 may have the following configuration in addition to the configuration illustrated in FIG. 2. Each unit described below may be included in the configuration illustrated in FIG. 2, for example.

That is, the mobile body devices 100, 100A, 100B, 100C, and 100D and the information processing apparatus 100E described above can also be configured as the following mobile body control system. FIG. 34 is a block diagram illustrating a configuration example of schematic functions of the mobile body control system to which the present technique can be applied.

An automatic driving control unit 212 and an operation control unit 235 of a vehicle control system 200 which is an example of the mobile body control system correspond to the execution unit 135 of the mobile body device 100. In addition, a detection unit 231 and a self-position estimation unit 232 of the automatic driving control unit 212 correspond to the obstacle map creation unit 133 of the mobile body device 100. Furthermore, a situation analysis unit 233 and a planning unit 234 of the automatic driving control unit 212 correspond to the action planning unit 134 of the mobile body device 100. The automatic driving control unit 212 may include blocks corresponding to the processing units of the control units 13, 13B, 13C, and 13E in addition to the blocks illustrated in FIG. 34.

Hereinafter, in a case where a vehicle provided with the vehicle control system 200 is distinguished from other vehicles, the vehicle is referred to as a host vehicle or an own vehicle.

The vehicle control system 200 includes an input unit 201, a data acquisition unit 202, a communication unit 203, an in-vehicle device 204, an output control unit 205, an output unit 206, a drive system control unit 207, a drive system 208, a body system control unit 209, a body system 210, a storage unit 211, and the automatic driving control unit 212. The input unit 201, the data acquisition unit 202, the communication unit 203, the output control unit 205, the drive system control unit 207, the body system control unit 209, the storage unit 211, and the automatic driving control unit 212 are connected to each other via a communication network 221. The communication network 221 includes, for example, an in-vehicle communication network, a bus, or the like conforming to an arbitrary standard such as a controller area network (CAN), a local interconnect network (LIN), a local area network (LAN), or FlexRay (registered trademark). Note that each unit of the vehicle control system 200 may be directly connected without going through the communication network 221.

Hereinafter, in a case where each unit of the vehicle control system 200 performs communication via the communication network 221, description of the communication network 221 will be omitted. For example, when the input unit 201 and the automatic driving control unit 212 communicate with each other via the communication network 221, it is simply described that the input unit 201 and the automatic driving control unit 212 communicate with each other.

The input unit 201 includes a device that is used for a passenger to input various kinds of data, instructions, and the like. For example, the input unit 201 includes an operation device such as a touch panel, a button, a microphone, a switch, and a lever, an operation device that can be input by a method by the voice, gesture, or the like other than a manual operation, and the like. Furthermore, for example, the input unit 201 may be a remote control device using infrared rays or other radio waves, or an external connection device such as a mobile device or a wearable device compatible with the operation of the vehicle control system 200. The input unit 201 generates an input signal on the basis of data, an instruction, or the like input by the passenger, and supplies the input signal to each unit of the vehicle control system 200.

The data acquisition unit 202 includes various sensors and the like that acquire data used for the processing of the vehicle control system 200, and supplies the acquired data to each unit of the vehicle control system 200.

For example, the data acquisition unit 202 includes various sensors for detecting a state or the like of the host vehicle. Specifically, for example, the data acquisition unit 202 includes a gyro sensor, an acceleration sensor, an inertial measurement unit (IMU), and a sensor for detecting an operation amount of an accelerator pedal, an operation amount of a brake pedal, a steering angle of a steering wheel, an engine speed, a motor speed, a wheel rotation speed, or the like.

Furthermore, for example, the data acquisition unit 202 includes various sensors for detecting information outside the host vehicle. Specifically, for example, the data acquisition unit 202 includes an imaging device such as a time of flight (ToF) camera, a stereo camera, a monocular camera, an infrared camera, and other cameras. Furthermore, for example, the data acquisition unit 202 includes an environment sensor for detecting climate, weather, or the like, and a surrounding information detection sensor for detecting an object around the host vehicle. The environment sensor includes, for example, a raindrop sensor, a fog sensor, a sunshine sensor, a snow sensor, and the like. The surrounding information detection sensor includes, for example, an ultrasonic sensor, a radar, light detection and ranging or laser imaging detection and ranging (LiDAR), sonar, and the like.

Furthermore, for example, the data acquisition unit 202 includes various sensors for detecting the current position of the host vehicle. Specifically, for example, the data acquisition unit 202 includes a global navigation satellite system (GNSS) receiver or the like that receives a GNSS signal from a GNSS satellite.

Furthermore, for example, the data acquisition unit 202 includes various sensors for detecting information inside the vehicle. Specifically, for example, the data acquisition unit 202 includes an imaging device that images a driver, a biological sensor that detects biological information of the driver, a microphone that collects sound in the vehicle interior, and the like. The biological sensor is provided, for example, on a seat surface, a steering wheel, or the like, and detects biological information of the passenger sitting on a seat or the driver gripping the steering wheel.

The communication unit 203 communicates with the in-vehicle device 204, various devices outside the vehicle, a server, a base station, and the like, transmits data supplied from each unit of the vehicle control system 200, and supplies received data to each unit of the vehicle control system 200. Note that the communication protocol supported by the communication unit 203 is not particularly limited, and the communication unit 203 can support a plurality of types of communication protocols.

For example, the communication unit 203 performs wireless communication with the in-vehicle device 204 by wireless LAN, Bluetooth (registered trademark), near field communication (NFC), wireless USB (WUSB), or the like. Furthermore, for example, the communication unit 203 performs wired communication with the in-vehicle device 204 by a universal serial bus (USB), a high-definition multimedia interface (HDMI) (registered trademark), a mobile high-definition link (MHL), or the like via a connection terminal (and a cable if necessary) (not illustrated).

Furthermore, for example, the communication unit 203 communicates with a device (for example, an application server or a control server) existing on an external network (for example, the Internet, a cloud network, or a company-specific network) via a base station or an access point. Furthermore, for example, the communication unit 203 communicates with a terminal (for example, a terminal of a pedestrian or a store, or a machine type communication (MTC) terminal) existing in the vicinity of the host vehicle by using a peer to peer (P2P) technique. Furthermore, for example, the communication unit 203 performs V2X communication such as vehicle to vehicle communication, vehicle to infrastructure communication, vehicle to home communication, and vehicle to pedestrian communication. Furthermore, for example, the communication unit 203 includes a beacon receiving unit, receives radio waves or electromagnetic waves transmitted from a wireless station or the like installed on a road, and acquires information such as a current position, congestion, traffic regulations, required time, or the like.

The in-vehicle device 204 includes, for example, a mobile device or a wearable device possessed by a passenger, an information device carried in or attached to the host vehicle, a navigation device that searches for a route to an arbitrary destination, and the like.

The output control unit 205 controls output of various kinds of information to a passenger of the host vehicle or the outside of the vehicle. For example, the output control unit 205 controls the output of visual information and auditory information from the output unit 206 by generating an output signal including at least one of the visual information (for example, image data) and the auditory information (for example, sound data) and supplying the output signal to the output unit 206. Specifically, for example, the output control unit 205 combines the image data imaged by different imaging devices of the data acquisition unit 202 to generate an overhead image, a panoramic image, or the like, and supplies the output signal including the generated image to the output unit 206. Furthermore, for example, the output control unit 205 generates the sound data including a warning sound, a warning message, or the like for danger such as collision, contact, or entry into a danger zone, and supplies the output signal including the generated sound data to the output unit 206.

The output unit 206 includes a device capable of outputting the visual information or the auditory information to a passenger of the host vehicle or the outside of the vehicle. For example, the output unit 206 includes a display device, an instrument panel, an audio speaker, a headphone, a wearable device such as a glasses-type display worn by a passenger, a projector, a lamp, and the like. The display device included in the output unit 206 may be a device that displays visual information in the visual field of the driver, such as a head-up display, a transmissive display, or a device having an augmented reality (AR) display function, in addition to the device having a normal display.

The drive system control unit 207 controls the drive system 208 by generating various control signals and supplying the control signals to the drive system 208. In addition, the drive system control unit 207 supplies the control signal to each unit other than the drive system 208 as necessary, and performs notification of a control state of the drive system 208 and the like.

The drive system 208 includes various devices relating to the drive system of the host vehicle. For example, the drive system 208 includes a driving force generation device for generating a driving force, such as an internal combustion engine or a driving motor, a driving force transmission mechanism for transmitting the driving force to wheels, a steering mechanism for adjusting a steering angle, a braking device for generating a braking force, an antilock brake system (ABS), an electronic stability control (ESC), an electric power steering device, and the like.

The body system control unit 209 controls the body system 210 by generating various control signals and supplying the control signals to the body system 210. In addition, the body system control unit 209 supplies the control signal to each unit other than the body system 210 as necessary, and performs notification of a control state of the body system 210 and the like.

The body system 210 includes various devices of a body system mounted on the vehicle body. For example, the body system 210 includes a keyless entry system, a smart key system, a power window device, a power seat, a steering wheel, an air conditioner, various lamps (for example, a head lamp, a back lamp, a brake lamp, a blinker, and a fog lamp), and the like.

The storage unit 211 includes, for example, a read only memory (ROM), a random access memory (RAM), a magnetic storage device such as a hard disc drive (HDD), a semiconductor storage device, an optical storage device, a magneto-optical storage device, and the like. The storage unit 211 stores various programs, data, and the like used by each unit of the vehicle control system 200. For example, the storage unit 211 stores map data such as a three-dimensional high-precision map such as a dynamic map, a global map that is less accurate than the high-precision map and covers a wide area, and a local map including information around the host vehicle.

The automatic driving control unit 212 performs control relating to the automatic driving such as autonomous traveling or driving support. Specifically, for example, the automatic driving control unit 212 performs cooperative control for the purpose of implementing functions of an advanced driver assistance system (ADAS) including collision avoidance or impact mitigation of the host vehicle, follow-up traveling based on an inter-vehicle distance, vehicle speed maintenance traveling, collision warning of the host vehicle, lane departure warning of the host vehicle, or the like. Furthermore, for example, the automatic driving control unit 212 performs cooperative control for the purpose of automatic driving or the like in which the vehicle autonomously travels without depending on the operation of the driver. The automatic driving control unit 212 includes the detection unit 231, the self-position estimation unit 232, the situation analysis unit 233, the planning unit 234, and the operation control unit 235.

The detection unit 231 detects various kinds of information required for controlling the automatic driving. The detection unit 231 includes a vehicle outside information detection unit 241, a vehicle inside information detection unit 242, and a vehicle state detection unit 243.

The vehicle outside information detection unit 241 performs detection processing of information outside the host vehicle on the basis of the data or signal from each unit of the vehicle control system 200. For example, the vehicle outside information detection unit 241 performs detection processing, recognition processing, and tracking processing of the object around the host vehicle, and detection processing of a distance to the object. Examples of the object as the detection target include a vehicle, a person, an obstacle, a structure, a road, a traffic light, a traffic sign, a road sign, and the like. Furthermore, for example, the vehicle outside information detection unit 241 performs detection processing of an environment around the host vehicle. The surrounding environment as the detection target includes, for example, climate, temperature, humidity, brightness, a state of a road surface, and the like. The vehicle outside information detection unit 241 supplies data indicating the result of the detection processing to the self-position estimation unit 232, a map analysis unit 251, a traffic rule recognition unit 252, and a situation recognition unit 253 of the situation analysis unit 233, an emergency avoidance unit 271 of the operation control unit 235, and the like.

The vehicle inside information detection unit 242 performs detection processing of information inside the vehicle on the basis of the data or signal from each unit of the vehicle control system 200. For example, the vehicle inside information detection unit 242 performs authentication processing and recognition processing of the driver, detection processing of a state of the driver, detection processing of the passenger, detection processing of the environment inside the vehicle, and the like. The state of the driver as the detection target includes, for example, a physical condition, a wakefulness level, a concentration level, a fatigue level, a line-of-sight direction, and the like. The environment inside the vehicle as the detection target includes, for example, temperature, humidity, brightness, odor, and the like. The vehicle inside information detection unit 242 supplies data indicating the result of the detection processing to the situation recognition unit 253 of the situation analysis unit 233, the emergency avoidance unit 271 of the operation control unit 235, and the like.

The vehicle state detection unit 243 performs detection processing of the state of the host vehicle on the basis of the data or signal from each unit of the vehicle control system 200. The state of the host vehicle as the detection target includes, for example, speed, acceleration, a steering angle, presence or absence and contents of abnormality, a state of driving operation, a position and inclination of a power seat, a state of door lock, and a state of other in-vehicle devices. The vehicle state detection unit 243 supplies data indicating the result of the detection processing to the situation recognition unit 253 of the situation analysis unit 233, the emergency avoidance unit 271 of the operation control unit 235, and the like.

The self-position estimation unit 232 performs estimation processing of the position, posture, and the like of the host vehicle on the basis of the data or signal from each unit of the vehicle control system 200 such as the vehicle outside information detection unit 241 and the situation recognition unit 253 of the situation analysis unit 233. Furthermore, the self-position estimation unit 232 generates a local map (hereinafter, referred to as a self-position estimation map) used for estimating the self-position as necessary. The self-position estimation map is, for example, a high-precision map using a technique such as simultaneous localization and mapping (SLAM). The self-position estimation unit 232 supplies data indicating the result of the estimation processing to the map analysis unit 251, the traffic rule recognition unit 252, the situation recognition unit 253, and the like of the situation analysis unit 233. Furthermore, the self-position estimation unit 232 stores the self-position estimation map in the storage unit 211.

The situation analysis unit 233 performs analysis processing of the host vehicle and the surrounding situation. The situation analysis unit 233 includes the map analysis unit 251, the traffic rule recognition unit 252, the situation recognition unit 253, and a situation prediction unit 254.

The map analysis unit 251 performs analysis processing of various maps stored in the storage unit 211 while using the data or signal from each unit of the vehicle control system 200 such as the self-position estimation unit 232 and the vehicle outside information detection unit 241 as necessary, and constructs a map including information required for the processing of the automatic driving. The map analysis unit 251 supplies the constructed map to the traffic rule recognition unit 252, the situation recognition unit 253, the situation prediction unit 254, and a route planning unit 261, an action planning unit 262, an operation planning unit 263, and the like of the planning unit 234.

The traffic rule recognition unit 252 performs recognition processing of traffic rules around the host vehicle on the basis of the data or signal from each unit of the vehicle control system 200 such as the self-position estimation unit 232, the vehicle outside information detection unit 241, and the map analysis unit 251. By this recognition processing, for example, the position and state of the signal around the host vehicle, contents of traffic regulations around the host vehicle, a lane on which the host vehicle can travel, and the like are recognized. The traffic rule recognition unit 252 supplies data indicating the result of the recognition processing to the situation prediction unit 254 and the like.

The situation recognition unit 253 performs recognition processing of a situation relating to the host vehicle on the basis of the data or signal from each unit of the vehicle control system 200 such as the self-position estimation unit 232, the vehicle outside information detection unit 241, the vehicle inside information detection unit 242, the vehicle state detection unit 243, and the map analysis unit 251. For example, the situation recognition unit 253 performs recognition processing of a situation of the host vehicle, a situation around the host vehicle, a situation of the driver of the host vehicle, and the like. In addition, the situation recognition unit 253 generates a local map (hereinafter, referred to as a situation recognition map) used for recognizing the situation around the host vehicle as necessary. The situation recognition map is, for example, an occupancy grid map.

The situation of the host vehicle as the recognition target includes, for example, the position, posture, and movement of the host vehicle (for example, speed, acceleration, and moving direction), and the presence or absence and contents of abnormality. The situation around the host vehicle as the recognition target includes, for example, the type and position of a surrounding stationary object, the type, position, and movement (for example, speed, acceleration, and moving direction) of a surrounding moving object, a surrounding road composition and a road surface condition, and the surrounding climate, temperature, humidity, and brightness. The state of the driver as the recognition target includes, for example, a physical condition, a wakefulness level, a concentration level, a fatigue level, movement of a line of sight, driving operation, and the like.

The situation recognition unit 253 supplies data (including the situation recognition map as necessary) indicating the result of the recognition processing to the self-position estimation unit 232, the situation prediction unit 254, and the like. In addition, the situation recognition unit 253 stores the situation recognition map in the storage unit 211.

The situation prediction unit 254 performs prediction processing of a situation relating to the host vehicle on the basis of the data or signal from each unit of the vehicle control system 200 such as the map analysis unit 251, the traffic rule recognition unit 252, and the situation recognition unit 253. For example, the situation prediction unit 254 performs prediction processing of a situation of the host vehicle, a situation around the host vehicle, a situation of the driver, and the like.

The situation of the host vehicle as the prediction target includes, for example, behavior of the host vehicle, occurrence of abnormality, a travelable distance, and the like. The situation around the host vehicle as the prediction target includes, for example, behavior of a moving object around the host vehicle, a change in the signal state, a change in the environment such as climate. The situation of the driver as the prediction target includes, for example, behavior and physical condition of the driver, and the like.

The situation prediction unit 254 supplies data indicating the result of the prediction processing together with the data from the traffic rule recognition unit 252 and the situation recognition unit 253 to the route planning unit 261, the action planning unit 262, and the operation planning unit 263 of the planning unit 234.

The route planning unit 261 plans a route to a destination on the basis of the data or signal from each unit of the vehicle control system 200 such as the map analysis unit 251 and the situation prediction unit 254. For example, the route planning unit 261 sets a route from the current position to the designated destination on the basis of the global map. In addition, for example, the route planning unit 261 appropriately changes the route on the basis of a situation such as a traffic jam, an accident, a traffic regulation, and construction, and a physical condition or the like of the driver. The route planning unit 261 supplies data indicating the planned route to the action planning unit 262 and the like.

The action planning unit 262 plans an action of the host vehicle for safely traveling the route, which is planned by the route planning unit 261, within a planned time on the basis of the data or signal from each unit of the vehicle control system 200 such as the map analysis unit 251 and the situation prediction unit 254. For example, the action planning unit 262 performs planning of start, stop, traveling direction (for example, forward movement, backward movement, left turn, right turn, direction change, and the like), traveling lane, traveling speed, overtaking, and the like. The action planning unit 262 supplies data indicating the planned action of the host vehicle to the operation planning unit 263 and the like.

The operation planning unit 263 plans the operation of the host vehicle for realizing the action planned by the action planning unit 262, on the basis of the data or signal from each unit of the vehicle control system 200 such as the map analysis unit 251 and the situation prediction unit 254. For example, the operation planning unit 263 performs planning of acceleration, deceleration, a travel trajectory, and the like. The operation planning unit 263 supplies data indicating the planned operation of the host vehicle to an acceleration and deceleration control unit 272 and a direction control unit 273 of the operation control unit 235, and the like.

The operation control unit 235 controls the operation of the host vehicle. The operation control unit 235 includes the emergency avoidance unit 271, the acceleration and deceleration control unit 272, and the direction control unit 273.

The emergency avoidance unit 271 performs detection processing of an emergency such as collision, contact, entry into a danger zone, abnormality of the driver, or abnormality of the vehicle on the basis of the detection result of the vehicle outside information detection unit 241, the vehicle inside information detection unit 242, and the vehicle state detection unit 243. In a case of detecting the occurrence of an emergency, the emergency avoidance unit 271 plans the operation of the host vehicle for avoiding an emergency such as a sudden stop or a sudden turn. The emergency avoidance unit 271 supplies data indicating the planned operation of the host vehicle to the acceleration and deceleration control unit 272, the direction control unit 273, and the like.

The acceleration and deceleration control unit 272 performs acceleration and deceleration control for realizing the operation of the host vehicle planned by the operation planning unit 263 or the emergency avoidance unit 271. For example, the acceleration and deceleration control unit 272 calculates a control target value of the driving force generation device or the braking device for realizing planned acceleration, deceleration, or sudden stop, and supplies a control command indicating the calculated control target value to the drive system control unit 207.

The direction control unit 273 performs direction control for realizing the operation of the host vehicle planned by the operation planning unit 263 or the emergency avoidance unit 271. For example, the direction control unit 273 calculates a control target value of the steering mechanism for realizing the traveling trajectory or the sudden turn planned by the operation planning unit 263 or the emergency avoidance unit 271, and supplies a control command indicating the calculated control target value to the drive system control unit 207.

### 8-3. Others

Furthermore, among the processing described in each of the embodiments described above, all or a part of the processing described as being automatically performed can be manually performed, or all or a part of the processing described as being manually performed can be automatically performed by a known method. In addition, the processing procedure, specific name, and information including various kinds of data and parameters illustrated in the document and the drawings can be arbitrarily changed unless otherwise specified. For example, the various kinds of information illustrated in the drawings are not limited to the illustrated information.

In addition, each component of each apparatus illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in an arbitrary unit according to various loads, usage situations, and the like.

In addition, the embodiments and modifications described above can be appropriately combined within a range in which the processing contents do not contradict each other.

Furthermore, the effects described in the present specification are merely examples and are not limited, and other effects may be provided.

### 9. Effects According to Present Disclosure

As described above, the information processing apparatus (the mobile body devices 100, 100A, 100B, 100C, and 100D, and the information processing apparatus 100E in the embodiments) according to the present disclosure includes the first acquisition unit (the first acquisition unit 131 in the embodiment), the second acquisition unit (the second acquisition unit 132 in the embodiment), and the obstacle map creation unit (the obstacle map creation unit 133 in the embodiment). The first acquisition unit acquires the distance information between the measurement target and the distance measurement sensor, which is measured by the distance measurement sensor (the distance measurement sensor 141 in the embodiment). The second acquisition unit acquires the position information of the reflector that mirror-reflects the detection target detected by the distance measurement sensor. The obstacle map creation unit creates the obstacle map on the basis of the distance information acquired by the first acquisition unit and the position information of the reflector acquired by the second acquisition unit. In addition, the obstacle map creation unit creates a second obstacle map by specifying the first area in a first obstacle map including the first area created by the mirror reflection of the reflector on the basis of the position information of the reflector, integrating the second area, which is obtained by inverting the specified first area with respect to the position of the reflector, into the first obstacle map, and deleting the first area from the first obstacle map.

As a result, since the information processing apparatus according to the present disclosure can create the second obstacle map by integrating the second area, which is obtained by inverting the first area created by mirror reflection of the reflector, into the first obstacle map, and deleting the first area from the first obstacle map, it is possible to appropriately create the map even in a case where there is an obstacle that performs mirror reflection. Even in a case where there is a blind spot, the information processing apparatus can also add information of an area detected by reflection of the reflector to the obstacle map, and thus it is possible to appropriately create the map by reducing the area as a blind spot. Therefore, the information processing apparatus can make a more appropriate action plan using the appropriately created map.

Furthermore, the information processing apparatus includes the action planning unit (the action planning unit 134 in the embodiment). The action planning unit decides the action plan on the basis of the obstacle map created by the obstacle map creation unit. As a result, the information processing apparatus can appropriately decide the action plan using the created map.

Further, the first acquisition unit acquires the distance information measured by the distance measurement sensor which is an optical sensor. The second acquisition unit acquires the position information of the reflector that mirror-reflects the detection target that is an electromagnetic wave detected by the distance measurement sensor. As a result, the information processing apparatus can appropriately create the map using the optical sensor even in a case where there is an obstacle that performs mirror reflection.

Further, the second acquisition unit acquires the position information of the reflector included in an imaging range imaged by an imaging unit (the image sensor 142 in the embodiment). As a result, the information processing apparatus can appropriately create the map by acquiring the position information of the reflector by the imaging unit even in a case where there is an obstacle that performs mirror reflection.

Furthermore, the information processing apparatus includes the object recognition unit (the object recognition unit 136 in the embodiment). The object recognition unit recognizes the object reflected in the reflector imaged by the imaging unit. As a result, the information processing apparatus can appropriately recognize the object reflected in the reflector imaged by the imaging unit. Therefore, the information processing apparatus can make a more appropriate action plan using the information of the recognized object.

Furthermore, the information processing apparatus includes the object motion estimation unit (the object motion estimation unit 137 in the embodiment). The object motion estimation unit detects the moving direction or speed of the object recognized by the object recognition unit, on the basis of a change over time of the distance information measured by the distance measurement sensor. As a result, the information processing apparatus can appropriately estimate the motion state of the object reflected in the reflector. Therefore, the information processing apparatus can make a more appropriate action plan using the information of the estimated motion state of the object.

Further, the obstacle map creation unit integrates the second area into the first obstacle map by matching feature points of the first area with feature points which correspond to the first area and are measured as the measurement target in the first obstacle map. As a result, the information processing apparatus can accurately integrate the second area into the first obstacle map, and can appropriately create the map even in a case where there is an obstacle that performs mirror reflection.

Further, the obstacle map creation unit creates the obstacle map that is two-dimensional information. As a result, the information processing apparatus can create the obstacle map that is two-dimensional information, and can appropriately create the map even in a case where there is an obstacle that performs mirror reflection.

Further, the obstacle map creation unit creates the obstacle map that is three-dimensional information. As a result, the information processing apparatus can create the obstacle map that is three-dimensional information, and can appropriately create the map even in a case where there is an obstacle that performs mirror reflection.

Further, the obstacle map creation unit creates the second obstacle map in which the position of the reflector is set as the obstacle. As a result, the information processing apparatus can appropriately create the map by recognizing the position where the reflector is present as the obstacle even in a case where there is an obstacle that performs mirror reflection.

Further, the second acquisition unit acquires the position information of the reflector that is a mirror. As a result, the information processing apparatus can appropriately create the map in consideration of the information of the area reflected in the mirror.

Further, the first acquisition unit acquires the distance information from the distance measurement sensor to the measurement target located in the surrounding environment. The second acquisition unit acquires the position information of the reflector located in the surrounding environment. As a result, the information processing apparatus can appropriately create the map even in a case where there is an obstacle that performs mirror reflection, in the surrounding environment.

Further, the obstacle map creation unit creates the second obstacle map in which the second area obtained by inverting the first area with respect to the position of the reflector is integrated into the first obstacle map, on the basis of the shape of the reflector. As a result, the information processing apparatus can accurately integrate the second area into the first obstacle map according to the shape of the reflector, and can appropriately create the map even in a case where there is an obstacle that performs mirror reflection.

Further, the obstacle map creation unit creates the second obstacle map in which the second area obtained by inverting the first area with respect to the position of the reflector is integrated into the first obstacle map, on the basis of the shape of the surface of the reflector facing the distance measurement sensor. As a result, the information processing apparatus can accurately integrate the second area into the first obstacle map according to the shape of the surface of the reflector facing the distance measurement sensor, and can appropriately create the map even in a case where there is an obstacle that performs mirror reflection.

Further, the obstacle map creation unit creates the second obstacle map in which the second area including the blind spot area that is the blind spot from the position of the distance measurement sensor is integrated into the first obstacle map. As a result, the information processing apparatus can appropriately create the map even in a case where there is an area that is a blind spot from the position of the distance measurement sensor.

Further, the second acquisition unit acquires the position information of the reflector located at a junction of at least two roads. The obstacle map creation unit creates the second obstacle map in which the second area including the blind spot area corresponding to the junction is integrated into the first obstacle map. As a result, the information processing apparatus can appropriately create the map even in a case where there is an area, which is a blind spot, at a junction of two roads.

Further, the second acquisition unit acquires the position information of the reflector located at an intersection. The obstacle map creation unit creates the second obstacle map in which the second area including the blind spot area corresponding to the intersection is integrated into the first obstacle map. As a result, the information processing apparatus can appropriately create the map even in a case where there is an area, which is a blind spot, at an intersection.

Further, the second acquisition unit acquires the position information of the reflector that is a curved mirror.

As a result, the information processing apparatus can appropriately create the map in consideration of the information of the area reflected in the curved mirror.

### 10. Hardware Configuration

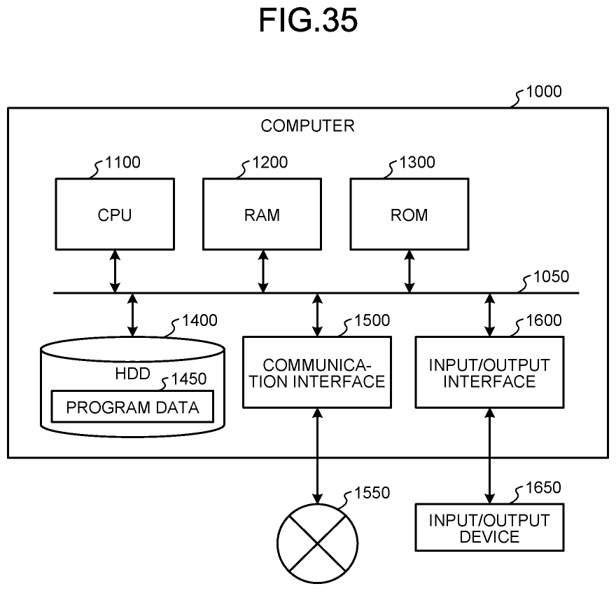

An information device such as the mobile body devices 100, 100A, 100B, 100C, and 100D and the information processing apparatus 100E according to each of the embodiments described above is realized by, for example, a computer 1000 having a configuration as illustrated in FIG. 35. FIG. 35 is a hardware configuration diagram illustrating an example of the computer 1000 that implements the functions of the information processing apparatus such as the mobile body devices 100 and 100A to 100D and the information processing apparatus 100E. Hereinafter, the mobile body device 100 according to the first embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records the information processing program according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like. For example, in a case where the computer 1000 functions as the information processing apparatus 100 according to the embodiment, the CPU 1100 of the computer 1000 realizes the functions of the control unit 13 and the like by executing the information processing program loaded on the RAM 1200. In addition, the HDD 1400 stores the information processing program according to the present disclosure and data in the storage unit 12. Note that the CPU 1100 executes the program data 1450 by reading the program data 1450 from the HDD 1400, but as another example, may acquire these programs from another device via the external network 1550.

Note that the present technology can also have the following configurations.

(1)

An information processing apparatus comprising:

a first acquisition unit that acquires distance information between a measurement target and a distance measurement sensor, which is measured by the distance measurement sensor;

a second acquisition unit that acquires position information of a reflector that mirror-reflects a detection target detected by the distance measurement sensor; and

an obstacle map creation unit that creates an obstacle map on the basis of the distance information acquired by the first acquisition unit and the position information of the reflector acquired by the second acquisition unit,

wherein the obstacle map creation unit creates a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

(2)

The information processing apparatus according to (1), further comprising:

an action planning unit that decides an action plan on the basis of the obstacle map created by the obstacle map creation unit.

(3)

The information processing apparatus according to (1) or (2),

wherein the first acquisition unit acquires the distance information measured by the distance measurement sensor which is an optical sensor, and

the second acquisition unit acquires the position information of the reflector that mirror-reflects the detection target which is an electromagnetic wave detected by the distance measurement sensor.

(4)

The information processing apparatus according to any one of (1) to (3),

wherein the second acquisition unit acquires the position information of the reflector included in an imaging range imaged by an imaging unit.

(5)

The information processing apparatus according to (4), further comprising:

an object recognition unit that recognizes an object reflected in the reflector imaged by the imaging unit.

(6)

The information processing apparatus according to (5), further comprising:

an object motion estimation unit that detects a moving direction or speed of the object recognized by the object recognition unit, on the basis of a change over time of the distance information measured by the distance measurement sensor.

(7)

The information processing apparatus according to any one of (1) to (6),

wherein the obstacle map creation unit integrates the second area into the first obstacle map by matching feature points of the first area with feature points which correspond to the first area and are measured as the measurement target in the first obstacle map.

(8)

The information processing apparatus according to any one of (1) to (7),

wherein the obstacle map creation unit creates the obstacle map that is two-dimensional information.

(9)

The information processing apparatus according to any one of (1) to (7),

wherein the obstacle map creation unit creates the obstacle map that is three-dimensional information.

(10)

The information processing apparatus according to any one of (1) to (9),

wherein the obstacle map creation unit creates the second obstacle map by setting a position of the reflector as an obstacle.

(11)

The information processing apparatus according to any one of (1) to (10), wherein the second acquisition unit acquires the position information of the reflector that is a mirror.

(12)

The information processing apparatus according to any one of (1) to (11),

wherein the first acquisition unit acquires the distance information from the distance measurement sensor to the measurement target located in a surrounding environment, and

the second acquisition unit acquires the position information of the reflector located in the surrounding environment.

(13)

the information processing apparatus according to any one of (1) to (12),

wherein the obstacle map creation unit creates the second obstacle map in which the second area obtained by inverting the first area with respect to a position of the reflector is integrated into the first obstacle map, on the basis of a shape the reflector.

(14)

The information processing apparatus according to (13),

wherein the obstacle map creation unit creates the second obstacle map in which the second area obtained by inverting the first area with respect to the position of the reflector is integrated into the first obstacle map, on the basis of a shape of a surface of the reflector facing the distance measurement sensor.

(15)

The information processing apparatus according to any one of (1) to (14),

wherein the obstacle map creation unit creates the second obstacle map in which the second area including a blind spot area that is a blind spot from a position of the distance measurement sensor is integrated into the first obstacle map.

(16)

The information processing apparatus according to (15),

wherein the second acquisition unit acquires the position information of the reflector located at a junction of at least two roads, and

the obstacle map creation unit creates the second obstacle map in which the second area including the blind spot area corresponding to the junction is integrated into the first obstacle map.

(17)

The information processing apparatus according to (15) or (16),

wherein the second acquisition unit acquires the position information of the reflector located at an intersection, and

the obstacle map creation unit creates the second obstacle map in which the second area including the blind spot area corresponding to the intersection is integrated into the first obstacle map.

(18)

The information processing apparatus according to (16) or (17),

wherein the second acquisition unit acquires the position information of the reflector that is a curved mirror.

(19)

An information processing method executing processing of:

acquiring distance information between a measurement target and a distance measurement sensor, which is measured by the distance measurement sensor;

acquiring position information of a reflector that mirror-reflects a detection target detected by the distance measurement sensor;

creating an obstacle map on the basis of the distance information and the position information of the reflector; and

creating a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

(20)

An information processing program of causing execution of processing of:

acquiring distance information between a measurement target and a distance measurement sensor, which is measured by the distance measurement sensor;

acquiring position information of a reflector that mirror-reflects a detection target detected by the distance measurement sensor;

creating an obstacle map on the basis of the distance information and the position information of the reflector; and

creating a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

### REFERENCE SIGNS LIST

100, 100A, 100B, 100C, 100D MOBILE BODY DEVICE
100E INFORMATION PROCESSING APPARATUS
11, 11E COMMUNICATION UNIT
12, 12C, 12E STORAGE UNIT
121 MAP INFORMATION STORAGE UNIT
122 THRESHOLD INFORMATION STORAGE UNIT
13, 13B, 13C, 13E CONTROL UNIT
131 FIRST ACQUISITION UNIT
132 SECOND ACQUISITION UNIT
133 OBSTACLE MAP CREATION UNIT
134 ACTION PLANNING UNIT
135 EXECUTION UNIT
136 OBJECT RECOGNITION UNIT
137 OBJECT MOTION ESTIMATION UNIT
138 CALCULATION UNIT
139 DETERMINATION UNIT
14, 14B, 14C, 14D SENSOR UNIT
141, 141C, 141D DISTANCE MEASUREMENT SENSOR
142 IMAGE SENSOR
15, 15A DRIVE UNIT

1. An information processing apparatus comprising:
a first acquisition unit that acquires distance information between a measurement target and a distance measurement sensor, which is measured by the distance measurement sensor;
a second acquisition unit that acquires position information of a reflector that mirror-reflects a detection target detected by the distance measurement sensor; and
an obstacle map creation unit that creates an obstacle map on the basis of the distance information acquired by the first acquisition unit and the position information of the reflector acquired by the second acquisition unit,
wherein the obstacle map creation unit creates a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

2. The information processing apparatus according to claim 1, further comprising:
an action planning unit that decides an action plan on the basis of the obstacle map created by the obstacle map creation unit.

3. The information processing apparatus according to claim 1,
wherein the first acquisition unit acquires the distance information measured by the distance measurement sensor which is an optical sensor, and
the second acquisition unit acquires the position information of the reflector that mirror-reflects the detection target which is an electromagnetic wave detected by the distance measurement sensor.

4. The information processing apparatus according to claim 1,
wherein the second acquisition unit acquires the position information of the reflector included in an imaging range imaged by an imaging unit.

5. The information processing apparatus according to claim 4, further comprising:
an object recognition unit that recognizes an object reflected in the reflector imaged by the imaging unit.

6. The information processing apparatus according to claim 5, further comprising:
an object motion estimation unit that detects a moving direction or speed of the object recognized by the object recognition unit, on the basis of a change over time of the distance information measured by the distance measurement sensor.

7. The information processing apparatus according to claim 1,
wherein the obstacle map creation unit integrates the second area into the first obstacle map by matching feature points of the first area with feature points which correspond to the first area and are measured as the measurement target in the first obstacle map.

8. The information processing apparatus according to claim 1,
wherein the obstacle map creation unit creates the obstacle map that is two-dimensional information.

9. The information processing apparatus according to claim 1,
wherein the obstacle map creation unit creates the obstacle map that is three-dimensional information.

10. The information processing apparatus according to claim 1,
wherein the obstacle map creation unit creates the second obstacle map by setting a position of the reflector as an obstacle.

11. The information processing apparatus according to claim 1,
wherein the second acquisition unit acquires the position information of the reflector that is a mirror.

12. The information processing apparatus according to claim 1,
wherein the first acquisition unit acquires the distance information from the distance measurement sensor to the measurement target located in a surrounding environment, and
the second acquisition unit acquires the position information of the reflector located in the surrounding environment.

13. The information processing apparatus according to claim 1,
wherein the obstacle map creation unit creates the second obstacle map in which the second area obtained by inverting the first area with respect to a position of the reflector is integrated into the first obstacle map, on the basis of a shape the reflector.

14. The information processing apparatus according to claim 13,
wherein the obstacle map creation unit creates the second obstacle map in which the second area obtained by inverting the first area with respect to the position of the reflector is integrated into the first obstacle map, on the basis of a shape of a surface of the reflector facing the distance measurement sensor.

15. The information processing apparatus according to claim 1,
wherein the obstacle map creation unit creates the second obstacle map in which the second area including a blind spot area that is a blind spot from a position of the distance measurement sensor is integrated into the first obstacle map.

16. The information processing apparatus according to claim 15,
wherein the second acquisition unit acquires the position information of the reflector located at a junction of at least two roads, and
the obstacle map creation unit creates the second obstacle map in which the second area including the blind spot area corresponding to the junction is integrated into the first obstacle map.

17. The information processing apparatus according to claim 15,
wherein the second acquisition unit acquires the position information of the reflector located at an intersection, and
the obstacle map creation unit creates the second obstacle map in which the second area including the blind spot area corresponding to the intersection is integrated into the first obstacle map.

18. The information processing apparatus according to claim 16,
wherein the second acquisition unit acquires the position information of the reflector that is a curved mirror.

19. An information processing method executing processing of:
acquiring distance information between a measurement target and a distance measurement sensor, which is measured by the distance measurement sensor;
acquiring position information of a reflector that mirror-reflects a detection target detected by the distance measurement sensor;
creating an obstacle map on the basis of the distance information and the position information of the reflector; and
creating a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.

20. An information processing program of causing execution of processing of:
acquiring distance information between a measurement target and a distance measurement sensor, which is measured by the distance measurement sensor;
acquiring position information of a reflector that mirror-reflects a detection target detected by the distance measurement sensor;
creating an obstacle map on the basis of the distance information and the position information of the reflector; and
creating a second obstacle map by specifying a first area in a first obstacle map including the first area created by mirror reflection of the reflector on the basis of the position information of the reflector, integrating a second area, which is obtained by inverting the specified first area with respect to a position of the reflector, into the first obstacle map, and deleting the first area from the first obstacle map.
